(19) United States
(12) Patent Application Publication
(10) Pub. No.: US 2026/0057563 A1
(43) Pub. Date: Feb. 26, 2026

(54) NEURAL ARCHITECTURE SEARCH FOR IMAGE GENERATION MODELS

(71) Applicant: ADOBE INC., SAN JOSE, CA (US)

(72) Inventors: Yan Kang, Kirkland, WA (US); Yuchen Liu, Mountain View, CA (US); Kanak Mahadik, San Jose, CA (US); Frieder Ludwig Anton Ganz, Hamburg (DE); Richard Zhang, Burlingame, CA (US)

(21) Appl. No.: 18/812,113

(22) Filed: Aug. 22, 2024

(51) Int. Cl. G06T 11/00; G06T 3/40; G06T 7/00

(52) U.S. Cl. CPC G06T 11/00; G06T 3/40; G06T 7/0002; G06T 2207/30168

(57) ABSTRACT

A method, apparatus, non-transitory computer readable medium, and system for image generation include obtaining a target quality level and an input prompt describing an image element and selecting an attention map size based on the target quality level. An image generation model generates an attention map having the attention map size selected based on the target quality level and then generates a synthetic image based on the input prompt and the attention map, where the synthetic image depicts the image element with the target quality level.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation and neural architecture search. Embodiments of the present disclosure include an image generation apparatus that receives an input prompt and a target quality level and searches for a subnet of a base image generation model for image generation. In some cases, the image generation apparatus performs neural architecture search (NAS) for diffusion models. The training stage involves dynamic training by randomly sampling subnets of the base image generation model. Then, the search stage includes searching for an optimal subnet given a target performance metric (e.g., target quality level, speed).

A method, apparatus, and non-transitory computer readable medium for image generation are described. One or more embodiments of the method, apparatus, and non-transitory computer readable medium include obtaining a target quality level and an input prompt describing an image element; selecting an attention map size based on the target quality level; generating, using an image generation model, an attention map having the attention map size selected based on the target quality level; and generating, using the image generation model, a synthetic image based on the input prompt and the attention map, wherein the synthetic image depicts the image element with the target quality level.

A method, apparatus, and non-transitory computer readable medium for image generation are described. One or more embodiments of the method, apparatus, and non-transitory computer readable medium include obtaining a training set including a training image; selecting a subnet of a base image generation model; and training, using the training set, the base image generation model by updating parameters of the selected subnet.

An apparatus and method for image generation are described. One or more embodiments of the apparatus and method include at least one processor; at least one memory including instructions executable by the at least one processor; and a base image generation model comprising parameters in the at least one memory, wherein the base image generation model comprises a plurality of subnets and each of the plurality of subnets is trained to generate images using a different number of computation resources, respectively.

### BRIEF DESCRIPTION OF THE DRAWINGS

FIG. 1 shows an example of an image generation system according to aspects of the present disclosure.

FIG. 2 shows an example of a method for conditional media generation according to aspects of the present disclosure.

FIG. 3 shows an example of synthetic images on different platforms according to aspects of the present disclosure.

FIG. 4 shows an example of synthetic images generated by adjusting model channels according to aspects of the present disclosure.

FIG. 5 shows an example of synthetic images generated by adjusting model depth according to aspects of the present disclosure.

FIG. 6 shows an example of synthetic images generated by an elastic machine learning model according to aspects of the present disclosure.

FIG. 7 shows an example of a method for image generation according to aspects of the present disclosure.

FIG. 8 shows an example of an image generation apparatus according to aspects of the present disclosure.

FIG. 9 shows an example of a base image generation model and subnet sampling according to aspects of the present disclosure.

FIG. 10 shows an example of method of sampling subnets according to aspects of the present disclosure.

FIG. 11 shows an example of a dynamic attention component according to aspects of the present disclosure.

FIG. 12 shows an example of synthetic images according to aspects of the present disclosure.

FIG. 13 shows an example of a guided latent diffusion model according to aspects of the present disclosure.

FIG. 14 shows an example of a U-Net architecture according to aspects of the present disclosure.

FIG. 15 shows an example of a diffusion process according to aspects of the present disclosure.

FIG. 16 shows an example of a method for image generation according to aspects of the present disclosure.

FIG. 17 shows an example of synthetic images for searching according to aspects of the present disclosure.

FIG. 18 shows an example of a search diagram showing speed versus similarity score according to aspects of the present disclosure.

FIG. 19 shows an example of a method for training a diffusion model according to aspects of the present disclosure.

FIG. 20 shows an example of a step-by-step procedure for training a machine learning model according to aspects of the present disclosure.

FIG. 21 shows an example of a method for training a base image generation model according to aspects of the present disclosure.

FIG. 22 shows an example of knowledge distillation according to aspects of the present disclosure.

FIGS. 23 and 24 show examples of synthetic images according to aspects of the present disclosure.

FIG. 25 shows an example of a computing device for image generation according to aspects of the present disclosure.

### DETAILED DESCRIPTION

The present disclosure describes systems and methods for image generation and neural architecture search. Embodiments of the present disclosure include an image generation apparatus that receives an input prompt and a target quality level and searches for a subnet of a base image generation model for image generation. In some cases, the image generation apparatus performs neural architecture search (NAS) for diffusion models. The training stage involves dynamic training by randomly sampling subnets of the base image generation model. Then, the search stage includes searching for an optimal subnet given a target performance metric (e.g., target quality level, speed).

Diffusion models are a class of generative neural networks that can be trained to generate new data with features similar to features found in training data. Diffusion models can be used in image synthesis, image completion tasks, etc. Conventional text-to-image generation models are not elastic and may take a long time to run due to the large number of parameters at full capacity. These models are difficult to implement on user devices that often have a limited amount of computation resources and memory.

In addition, conventional models are trained separately for different objectives and platforms (e.g., production, optimized, on-device model). Such models often lack flexibility (i.e., static model) to search for an optimal subnet given a target metric.

Embodiments of the present disclosure include an image generation apparatus configured to obtain an input prompt and a target quality level and then generate a synthetic image based on the input prompt. A base image generation model (e.g., a diffusion model) is trained to be an elastic model comprising a set of subnets and each of the subnets is trained to generate images using a different number of computation resources, respectively. In some examples, a dynamic attention component selects an attention map size based on a target quality level (e.g., reducing token size for key object and value object).

By optimizing a model for subnet training, smaller models can be used when a lower level of quality is targeted. Since these smaller models can utilize parameters of the larger model, training resources can be saved by avoiding the training of multiple independent models.

One or more embodiments include a machine learning model that is configured to form different subnet models for different usages. The overall machine learning model may be referred to as a “super-net” and the machine learning model includes weights that are shared between the various subnets. The machine learning model is trained during multiple training iterations, with different subnets selected for each training iteration. Subnets may be differentiated by the percentage of channels utilized within a block (i.e., adjusting channel size), by the number of layers skipped or pruned, by the variety of resolution at each stage of a U-Net (i.e., reducing resolution), or by a combination thereof. When it is time to generate an image, a subnet is selected according to computation constraints (e.g., performance metric such as speed, image pair similarity).

During training, an NAS apparatus can sample multiple subnets during each training step via skipping arbitrary layers, reducing channel size, and squeezing resolution. Furthermore, the NAS scheduler enables dynamic self-attention by dynamically reducing the size of the attention map, key input, and value input. In addition, the base image generation model is trained using knowledge distillation (e.g., intermediate stage-end feature map distillation). At inference or search time, the NAS apparatus can look for an optimal subnet based on a target quality level or performance metric.

The present disclosure describes systems and methods that improve on conventional image generation models by increasing efficiency in generating synthetic images. For example, users can select an optimal subnet from multiple subnets of a base image generation model according to user needs and device capacity (e.g., speed, target quality level). Embodiments of the present disclosure train a base model once by sampling different subnets at each training step. With a trained dynamic model, users can search variants (subnets) with different optimization targets. Additionally, the model performs dynamic self-attention by reducing the size of the attention map, key input, and value input. Accordingly, the number of computations is reduced, and image generation efficiency is increased via neural architecture search capacity.

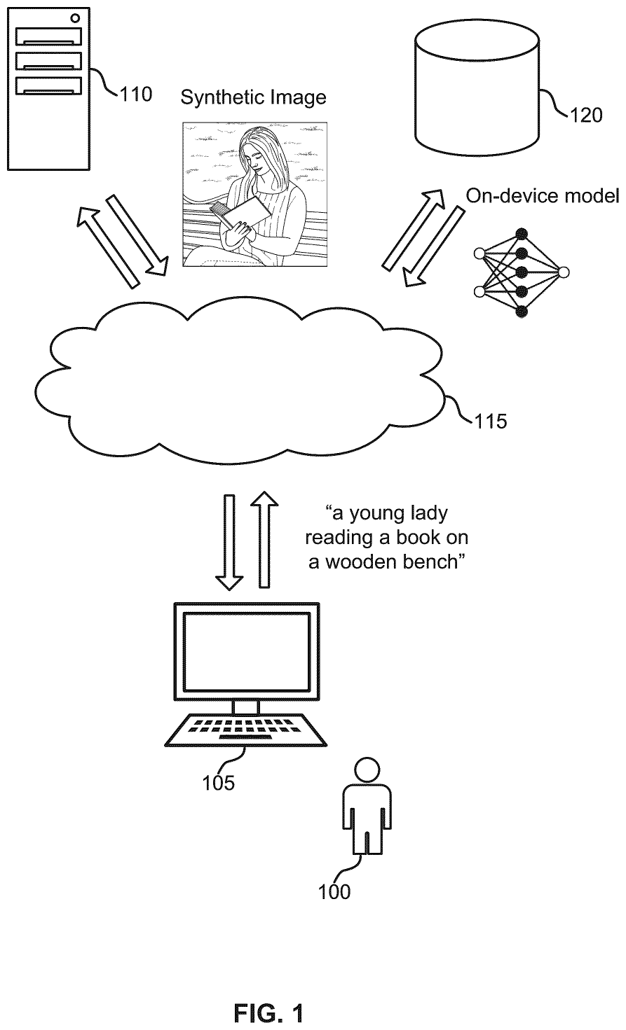

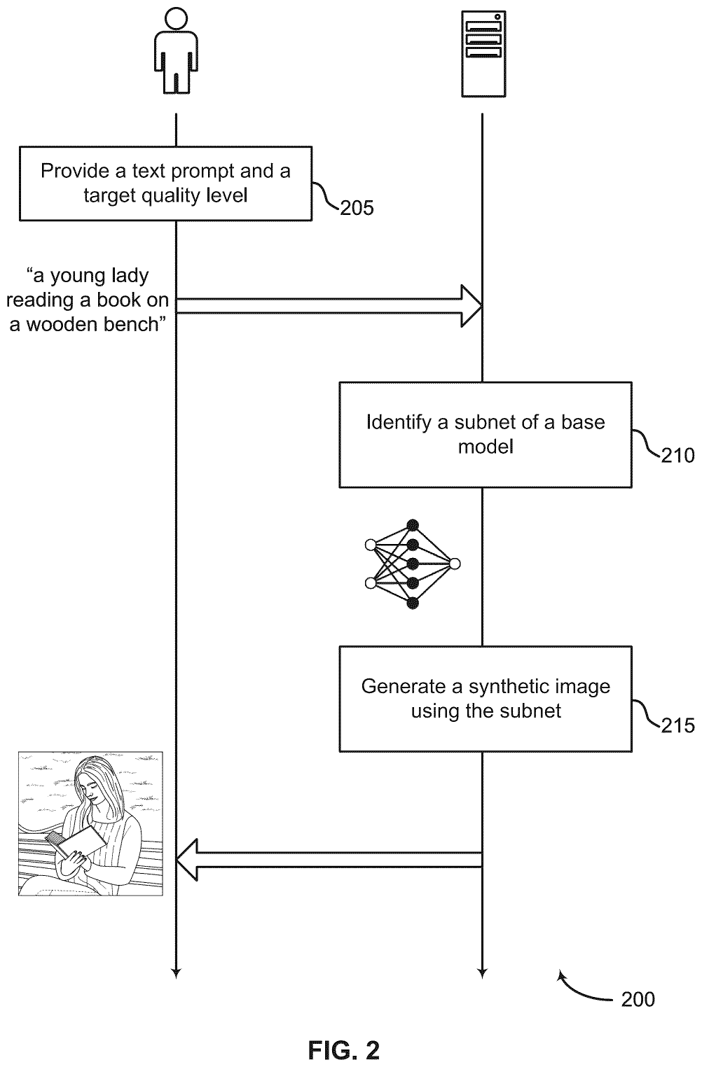

Examples of application in image generation context are provided with reference to FIGS. 2-6. Details regarding the architecture of an example image generation and neural architecture search system are provided with reference to FIGS. 1, 8-11, and 13-15. Details regarding the image generation process are provided with reference to FIGS. 2, 7 and 16.

### Image Generation

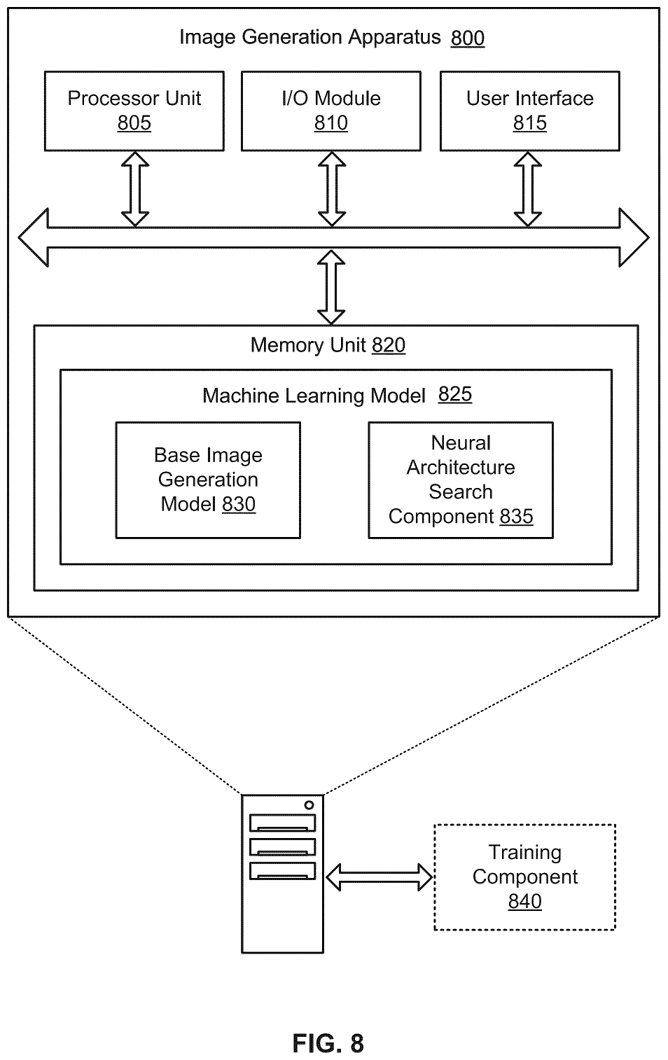

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 8.

In an example shown in FIG. 1, an input prompt is provided by user 100. For example, the input prompt is “a young lady reading a book on a wooden bench”. User 100 may provide a target quality level (e.g., low quality, medium quality, high quality). In some cases, user 100 may indicate a desired inferencing speed, image similarity, etc. The input prompt and the target quality level are transmitted to image generation apparatus 110, e.g., via user device 105 and cloud 115.

A base image generation model (e.g., a diffusion U-Net) is trained during multiple training iterations, with different subnets selected for each training iteration. Subnets may be differentiated by the percentage of channels utilized within a block (i.e., adjusting channel size), by the number of layers skipped or pruned, by the variety of resolution at each stage of a U-Net (i.e., reducing resolution), or by a combination thereof. When it is time to generate an image, a subnet is selected according to computation constraints (e.g., speed, image pair similarity). Image generation apparatus 110 searches through a set of subnets using a neural architecture search component and selects an optimal subnet.

Image generation apparatus 110 generates, using the selected subnet, a synthetic image based on the input prompt. The synthetic image includes an element or depicts an object in the scene based on the input prompt with the target quality level. The element or object is from the input prompt. Image generation apparatus 110 returns one or more synthetic images to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer-implemented network comprising a base image generation model and a neural architecture search component. Image generation apparatus 110 may also include a processor unit, a memory unit, an I/O module, and a user interface. A training component may be implemented on an apparatus other than image generation apparatus 110. The training component is used to train a base image generation model and one or more subnets of the base image generation model. Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 8-11 and 13-14. Further detail regarding the operation of image generation apparatus 110 is provided with reference to FIGS. 2, 7 and 16.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., training dataset including training input prompts and ground-truth images) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for conditional media generation according to aspects of the present disclosure. In some examples, method 200 describes an operation of the machine learning model 825 described with reference to FIG. 8 such as an application of the base image generation model 830 described with reference to FIG. 8. In some examples, these operations are performed by a system including a processor executing a set of codes to control functional elements of an apparatus.

Additionally or alternatively, steps of the method 200 are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides a text prompt and a target quality level. In some cases, the operations of this step refer to, or may be performed by, a user as described with reference to FIG. 1. A user provides a text prompt describing content to be included in a generated media item. For example, a user may provide the prompt “a young lady reading a book on a wooden bench”. In some examples, guidance can be provided in a form other than text, such as via an image, a sketch, or a layout.

At operation 210, the system identities a subnet of a base model by performing a neural architecture search. In some cases, the operations of this step refer to, or may be performed by, an image generation apparatus as described with reference to FIGS. 1 and 8.

At inference time, a user can select a subset (e.g., a smaller model compared to the full base model). The subnet (e.g., with a reduced attention map size) is selected to avoid using unnecessary computation resources to run the full model. During training, an NAS apparatus operates neural architecture search methods during the training of a diffusion model. In some cases, at inference time, selecting a subnet comprises an operation of selecting an attention map size.

The system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 215, the system generates a synthetic image using the subnet. In some cases, the operations of this step refer to, or may be performed by, an image generation apparatus as described with reference to FIGS. 1 and 8.

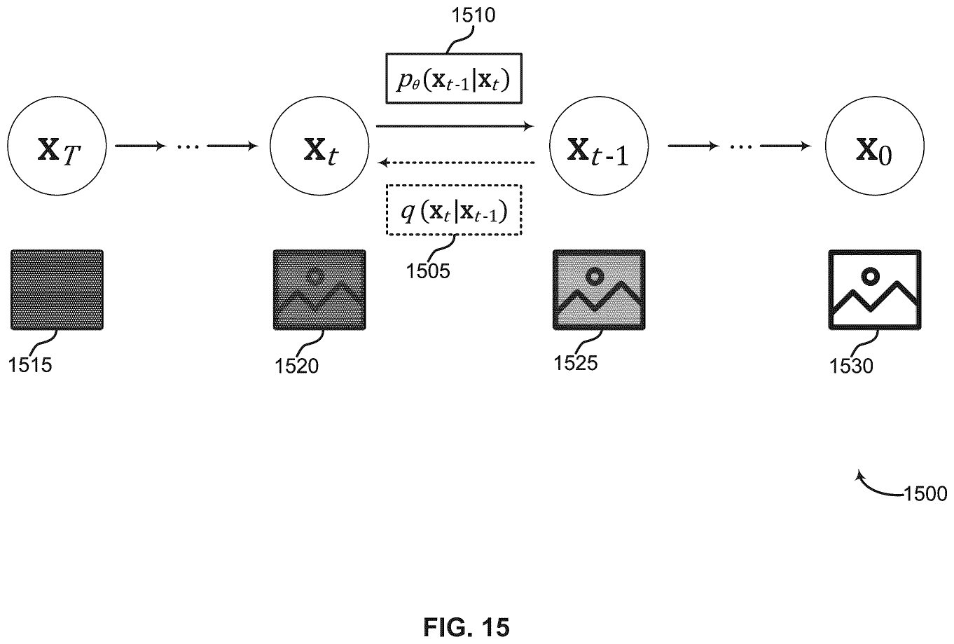

In some cases, a noise map is initialized that includes random noise. The noise map may be in a pixel space or a latent space. By initializing a media item with random noise, different variations of a media item including the content described by the conditional guidance can be generated. The system generates a media item based on the noise map and the conditional guidance vector. For example, the media item may be generated using a reverse diffusion process as described with reference to FIG. 15.

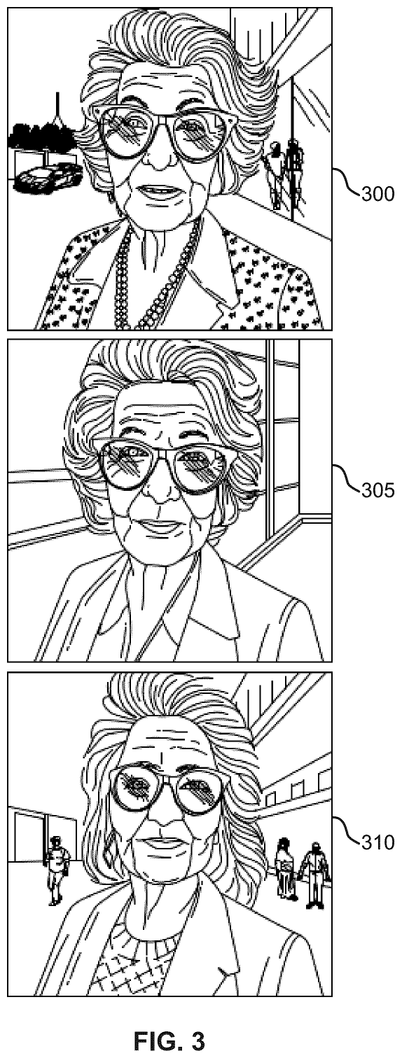

FIG. 3 shows an example of synthetic images on different platforms according to aspects of the present disclosure. The example shown includes the first synthetic image 300, second synthetic image 305, and third synthetic image 310.

In some examples, the first synthetic image 300 depicts a woman's face and upper body generated by a first model having a large number of parameters (e.g., a cloud-based production model). The first model is costly to train, performs a large number of computations, and can generate high-quality synthetic images.

The second synthetic image 305 depicts a woman's face and upper body generated by a second model (e.g., a cloud based optimized model). The second model includes fewer parameters and is less expensive to train compared to the first model. The second model can still generate high-quality synthetic images. The second model runs faster compared to the first model while maintaining substantially similar quality to the first model.

Third synthetic image 310 depicts a woman's face and upper body generated by a third model (e.g., an on-device model). The third model incurs reduced memory cost and can be implemented to run locally on a user device (e.g., user device 105 in FIG. 1). The image quality of third synthetic image 310 is decreased compared to first synthetic image 300 and second synthetic image 305 generated by the first model and the second model, respectively.

As illustrated in FIG. 3, synthetic images 300, 305, and 310 show a tradeoff between number of computations, image quality, and memory cost across different platforms. The first model (e.g., a cloud-based production model) provides the highest image quality at a relatively high cost. The second model (e.g., a cloud based optimized model) balances image quality and memory cost, offering a viable alternative for applications requiring near-production quality with reduced expenses. The third model (e.g., an on-device model) prioritizes cost efficiency, suitable for user electronic devices that have a more limited computation power and memory storage.

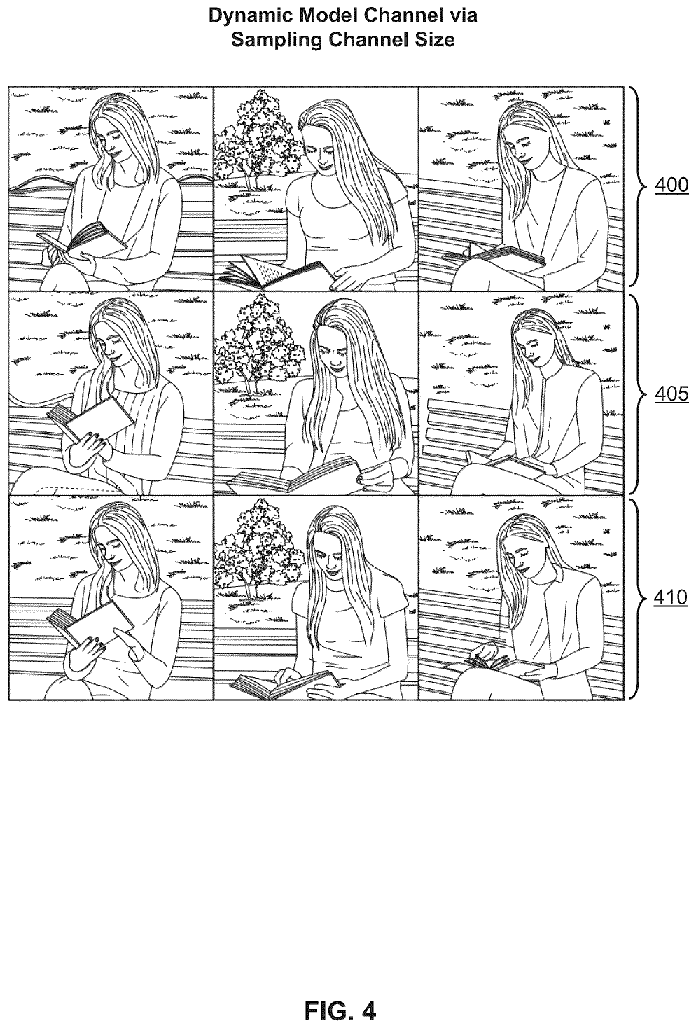

FIG. 4 shows an example of synthetic images generated by adjusting model channels according to aspects of the present disclosure. The example shown includes a first set of synthetic images 400, a second set of synthetic images 405, and a third set of synthetic images 410.

As an example shown in FIG. 4, the first set of synthetic images 400 is generated using a full-capacity model. The first set of synthetic images 400 has relatively high image quality due to using an image generation model trained to its full capacity. The first set of synthetic images 400 includes fine-grained details, making them suitable for users desiring high fidelity.

A second set of synthetic images 405 is generated using 80% of the channel capacity of a base image generation model. By dynamically sampling a subnet having 80% of the channels at training (i.e., adjusting channel size of a transformer layer), the second set of synthetic images 405 has decreased image quality compared to the first set of synthetic images 400, but increased computational efficiency. The second set of synthetic images 405 maintains a target level of detail.

A third set of synthetic images 410 is generated using 60% of the channel capacity of a base image generation model. The third set of synthetic images 410 is generated by a subnet sampling 60% of channel size (i.e., adjusting channel size of a transformer layer). The third set of synthetic images 410 has decreased image quality compared to the second set of synthetic images 405, but increased computational efficiency (e.g., consume less computational resource). The third set of synthetic images 410 maintains a target level of detail.

The three sets of synthetic images 400, 405, and 410 show a tradeoff between image quality and computation efficiency. A base image generation model (with reference to FIG. 8) may include a set of subnets and each of the set of subnets is trained to generate images using a different number of computation resources, respectively. In some examples, each of the set of subnets samples or identifies a subset of channels of the base image generation model. Dynamic sampling of channel size enables users to search for a subnet that fits a target quality level and meets a performance metric (e.g., speed, memory).

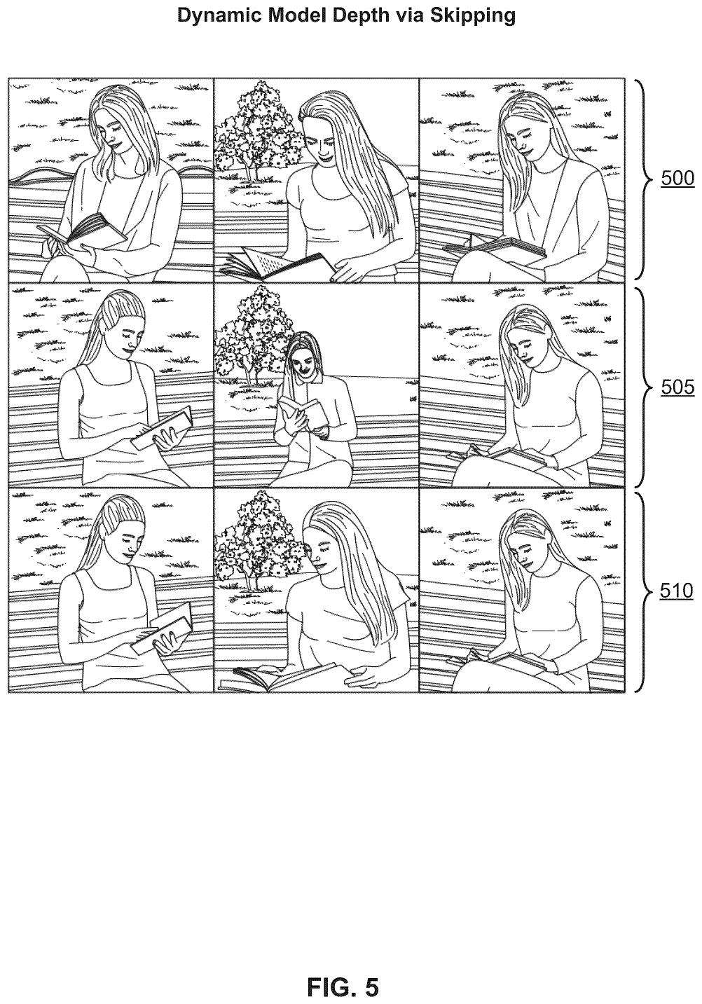

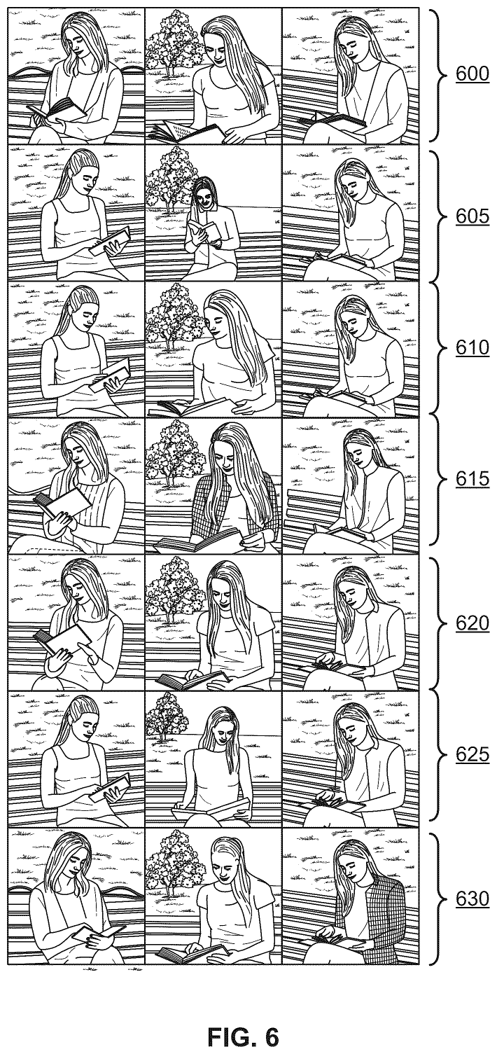

The first set of synthetic images 400 is an example of, or includes aspects of, the corresponding element described with reference to FIGS. 5 and 6. The second set of synthetic images 405 is an example of, or includes aspects of, the corresponding element described with reference to FIGS. 5 and 6. The third set of synthetic images 410 is an example of, or includes aspects of, the corresponding element described with reference to FIGS. 5 and 6.

FIG. 5 shows an example of synthetic images generated by adjusting model depth according to aspects of the present disclosure. The example shown includes the first set of synthetic images 500, second set of synthetic images 505, and third set of synthetic images 510.

The first set of synthetic images 500 is generated using a base image generation model at its full capacity (e.g., full model depth, no transformer layers are skipped or pruned). The base image generation model is an example of, or includes aspects of, the corresponding element described with reference to base image generation model 830 in FIG. 8. The first set of synthetic images 500 shows relatively high image quality due to using all layers of the base image generation model (i.e., not skipping any layers). The first set of synthetic images 500 appeals to users who desire the highest level of fidelity in generated images.

A second set of synthetic images 505 is generated using 84% depth of the base image generation model. By dynamically skipping 16% of the transformer layers at training (e.g., skipping one or more layers of a U-Net), the second set of synthetic images 505 has relatively less image quality compared to the first set of synthetic images 500, but increased computation efficiency. The second set of synthetic images 505 maintains a target level of detail.

A third set of synthetic images 510 is generated using 66% depth of the base image generation model. The third set of synthetic images 510 is generated by sampling or identifying a subset of layers of the base image generation model (e.g., skipping one or more transformer layers of a U-Net). More layers are skipped in this subnet compared to the subnet that generates the second set of synthetic images 505.

The sets of synthetic images 500, 505, and 510 show a tradeoff between image quality and computation efficiency. Dynamic adjustment of model depth enables users to search for a subnet that fits a target quality level and meets a performance metric (e.g., speed, memory).

The first set of synthetic images 500 is an example of, or includes aspects of, the corresponding element described with reference to FIGS. 4 and 6. The second set of synthetic images 505 is an example of, or includes aspects of, the corresponding element described with reference to FIGS. 4 and 6. Third set of synthetic images 510 is an example of, or includes aspects of, the corresponding element described with reference to FIGS. 4 and 6.

FIG. 6 shows an example of synthetic images generated by an elastic machine learning model according to aspects of the present disclosure. The example shown includes first set of synthetic images 600, second set of synthetic images 605, third set of synthetic images 610, fourth set of synthetic images 615, fifth set of synthetic images 620, sixth set of synthetic images 625, and seventh set of synthetic images 630.

The first set of synthetic images 600 images is generated using a base image generation model (e.g., a full capacity diffusion model). The first set of synthetic images 500 is generated using a base image generation model at its full capacity (e.g., full model depth, no transformer layers are skipped or pruned). The base image generation model is an example of, or includes aspects of, the corresponding element described with reference to base image generation model 830 in FIG. 8. The first set of synthetic images 600 shows relatively high image quality (e.g., highly detailed and preserve fidelity).

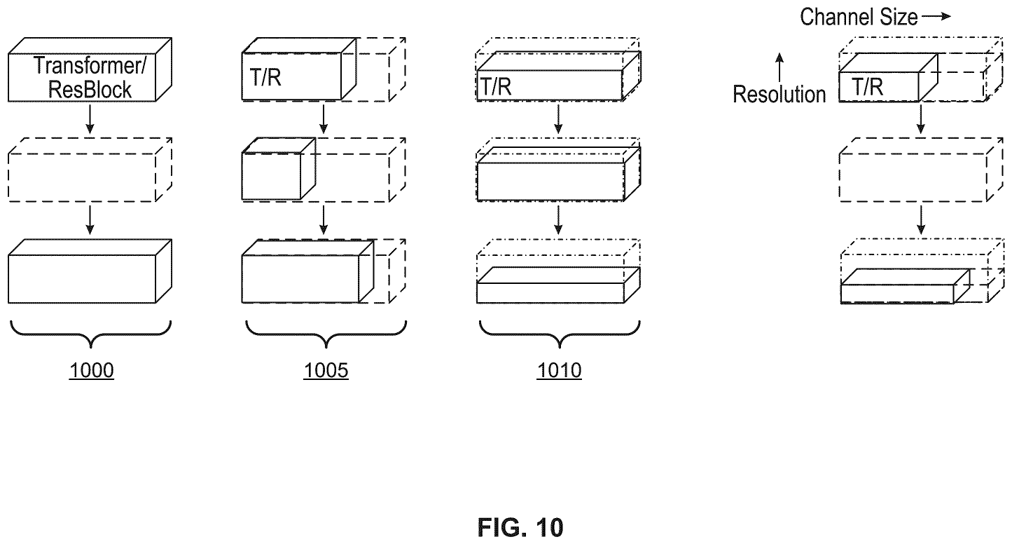

A second set of synthetic images 605 is generated using a subnet that samples or identifies 84% of the model depth of the base image generation model (e.g., skipping 16% of transformer layers of a U-Net). A third set of synthetic images 610 is generated using a subnet that samples of identifies 66% of the model depth of the base image generation model (e.g., skipping 34% of transformer layers of a U-Net). A fourth set of synthetic images 615 is generated using a subnet that samples or identifies 80% of the channels of the base image generation model (e.g., reducing channel size of a transformer layer by 20%). A fifth set of synthetic images 620 is generated using a subnet that samples or identifies 60% of the channels of the base image generation model (e.g., reducing channel size of a transformer layer by 40%). A sixth set of synthetic images 625 is generated using a subnet that reduces a resolution of a layer of the base image generation model using dynamic self-attention (e.g., squeezing resolution by 50% for all resolution in a U-Net). Details about reducing resolution via dynamic self-attention is further described in FIGS. 10-11 and 16. A seventh set of synthetic images 630 is generated by randomly sampling a subnet from the base image generation model (e.g., skipping layers, channel size reduction, resolution reduction).

From the sets of synthetic images 600, 605, 610, 615, 620, 625, and 630, an elastic image generation model can be trained by sampling a large number of subnets with various capacity (e.g., speed, performance). A base image generation model includes a set of subnets and each of the set of subnets is trained to generate images using a different number of computation resources, respectively.

The first set of synthetic images 600 is an example of, or includes aspects of, the corresponding element described with reference to FIGS. 4 and 5. The second set of synthetic images 605 is an example of, or includes aspects of, the corresponding element described with reference to FIGS. 4 and 5. Third set of synthetic images 610 is an example of, or includes aspects of, the corresponding element described with reference to FIGS. 4 and 5.

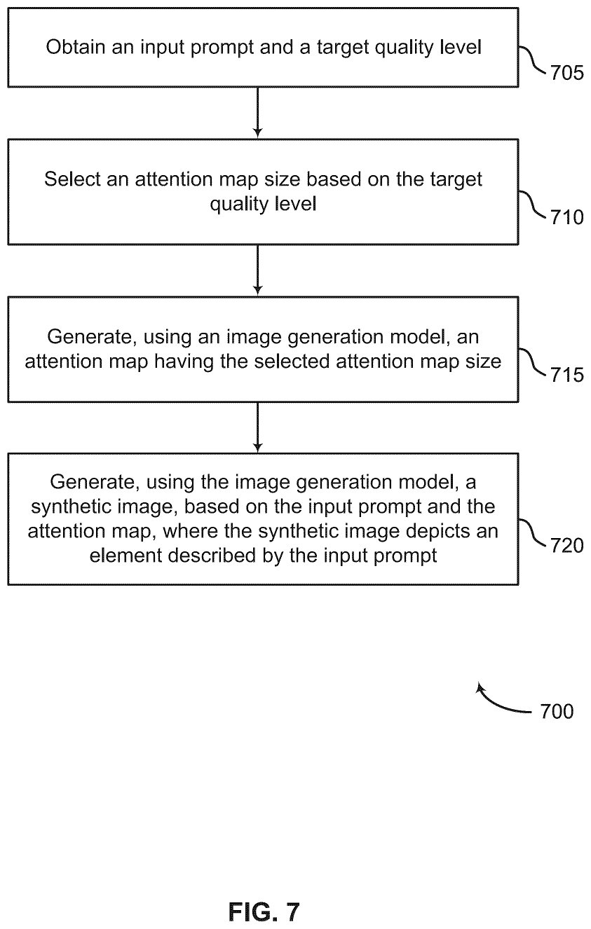

FIG. 7 shows an example of a method 700 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

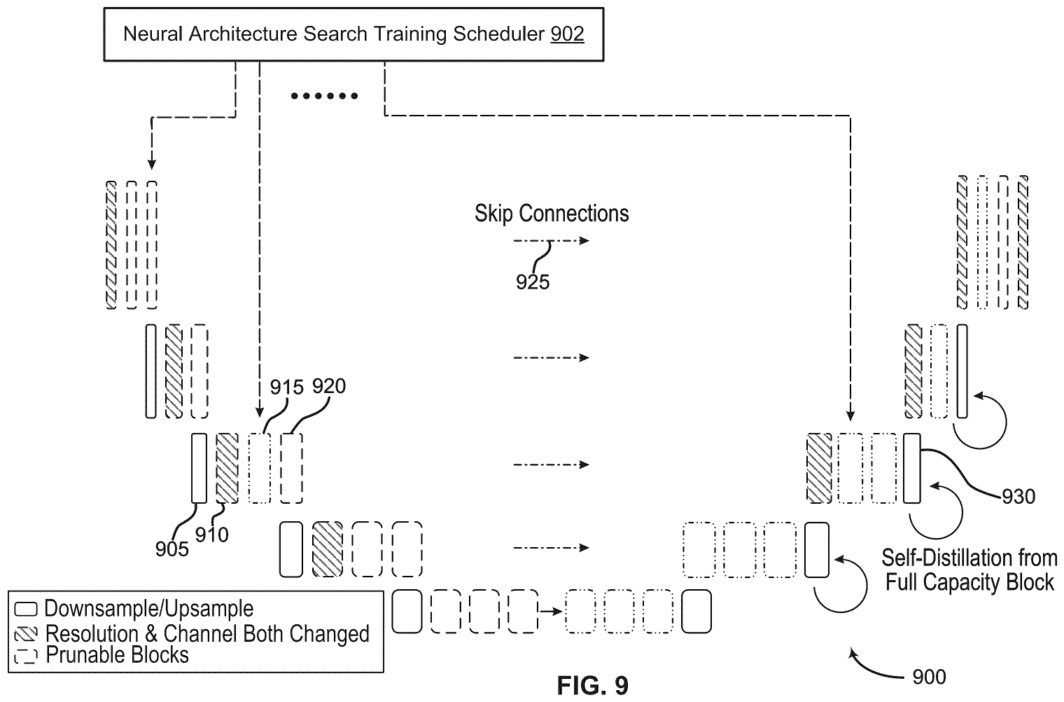

At operation 705, the system obtains an input prompt and a target quality level. In some cases, the operations of this step refer to, or may be performed by, a machine learning model as described with reference to FIGS. 8 and 9. In some examples, a target quality level is a parameter set by a user for image generation (e.g., low image quality, medium image quality, high image quality). The target quality level may also indicate computation resource or usage at inference (e.g., speed).

At operation 710, the system selects an attention map size based on the target quality level. In some cases, the operations of this step refer to, or may be performed by, a machine learning model as described with reference to FIGS. 8 and 9. For example, a subnet of a base image generation model can be selected, where the subnet has the selected attention map size and the base image generation model has a larger attention map size.

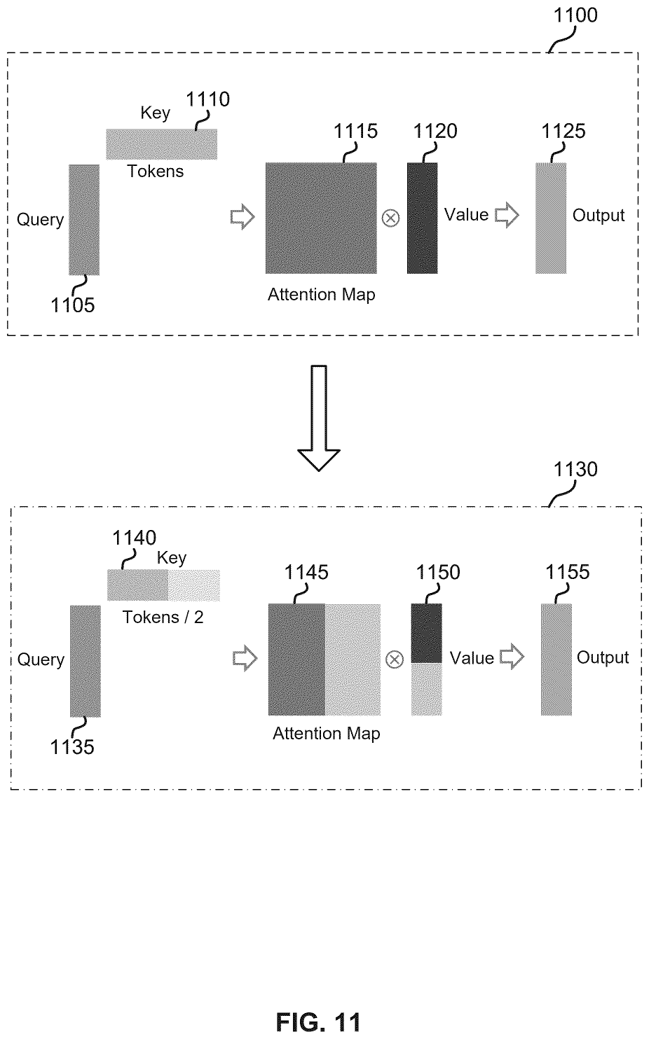

Self-attention complexity grows quadratically regarding the token size (e.g., H×W). A dynamic attention component of the machine learning model performs dynamic self-attention and increases computation efficiency by reducing token size of key object and value object. The term “self-attention” refers to a machine learning model in which representations of the input interact with each other to determine attention weights for the input. Self-attention can be distinguished from other attention models because the attention weights are determined at least in part by the input itself. Detail regarding selecting an attention map size is also described in FIG. 11.

At operation 715, the system generates, using an image generation model, an attention map having the selected attention map size. In some cases, the operations of this step refer to, or may be performed by, a machine learning model as described with reference to FIGS. 8 and 9.

In an embodiment, a machine learning model generates an attention map by selecting a number of tokens for a key object, where the attention map comprises a product of the key object and a query object; selecting a number of tokens for a value object corresponding to the number of tokens for the key object; and computing a product of the attention map and the value object. Detail with regard to generating an attention map is described in FIG. 11.

An attention map is a representation that shows how much importance or weight the model assigns to different parts of the input data when making predictions or generating outputs. Attention maps are used in models employing attention mechanisms, such as Transformer models, to visualize and understand which parts of the input are being focused on at each step of the computation.

In some cases, an attention function is described as mapping a query and a set of key-value pairs to an output, where the query, keys, values, and output are all vectors. The output is computed as a weighted sum of the values, where the weight assigned to each value is computed by a compatibility function of the query with the corresponding key.

In some examples, machine learning model 825 with reference to FIG. 8 computes the attention function on a set of queries simultaneously, packed together into a matrix Q. The keys and values are also packed together into matrices K and V. Machine learning model 825 computes the matrix of outputs as:

$$Attention ( Q , K , V ) = soft max ( \frac{{QK}^{T}}{\sqrt{{d}_{k}}} ) V \qquad ( 1 )$$

At operation 720, the system generates, using the image generation model, a synthetic image, based on the input prompt and the attention map, where the synthetic image depicts an element described by the input prompt. In some cases, the operations of this step refer to, or may be performed by, a machine learning model as described with reference to FIGS. 8 and 9.

In an example shown in FIG. 1, the input prompt is “a young lady reading a book on a wooden bench”. The synthetic image depicts an element described by the input prompt (e.g., “lady”, “book”, “bench”).

In FIGS. 1-7, a method, apparatus, and non-transitory computer readable medium for image generation are described. One or more aspects of the method, apparatus, and non-transitory computer readable medium include obtaining an input prompt and a target quality level; selecting an attention map size based on the target quality level; generating, using an image generation model, an attention map having the selected attention map size; and generating, using the image generation model, a synthetic image, based on the input prompt and the attention map, wherein the synthetic image depicts an element described by the input prompt.

Some examples of the method, apparatus, and non-transitory computer readable medium further include obtaining performance information, wherein the attention map size is selected based on the performance information.

Some examples of the method, apparatus, and non-transitory computer readable medium further include selecting a subnet of a base image generation model based on the target quality level, wherein the image generation model comprises the subnet of the base image generation model.

Some examples of the method, apparatus, and non-transitory computer readable medium further include selecting a number of tokens for a key object, wherein the attention map comprises a product of the key object and a query object.

Some examples of the method, apparatus, and non-transitory computer readable medium further include selecting a number of tokens for a value object corresponding to the number of tokens for the key object. Some examples further include computing a product of the attention map and the value object.

### Network Architecture

FIG. 8 shows an example of an image generation apparatus 800 according to aspects of the present disclosure. The example shown includes image generation apparatus 800, processor unit 805, I/O module 810, user interface 815, memory unit 820, machine learning model 825, and training component 840. Image generation apparatus 800 is an example of, or includes aspects of, the corresponding element described with reference to FIG. 1.

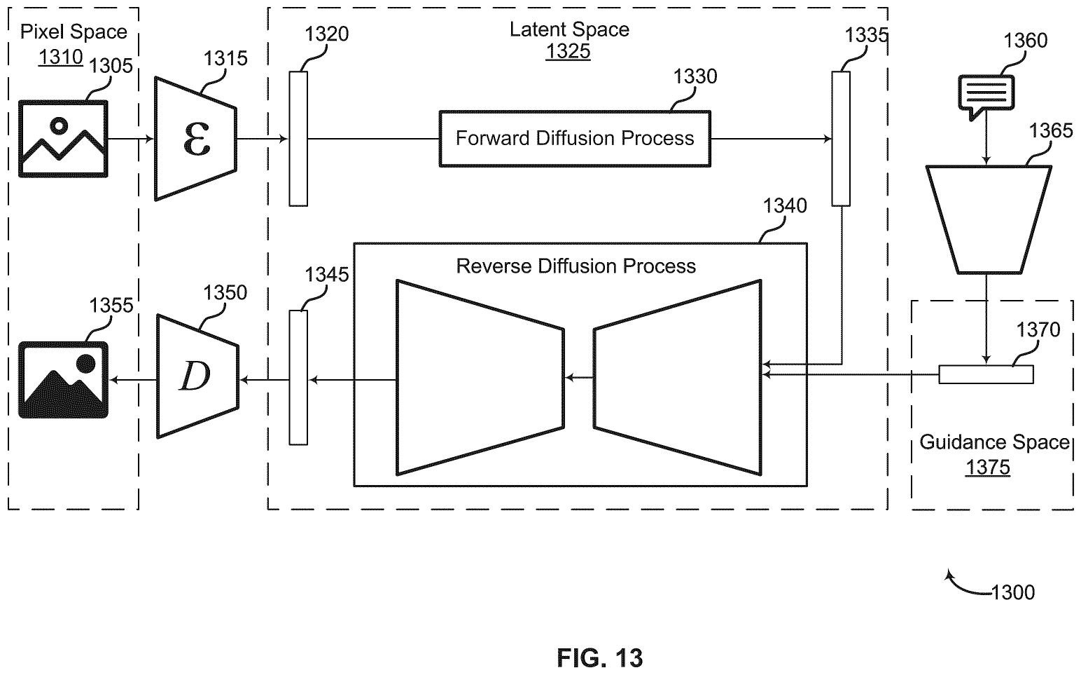

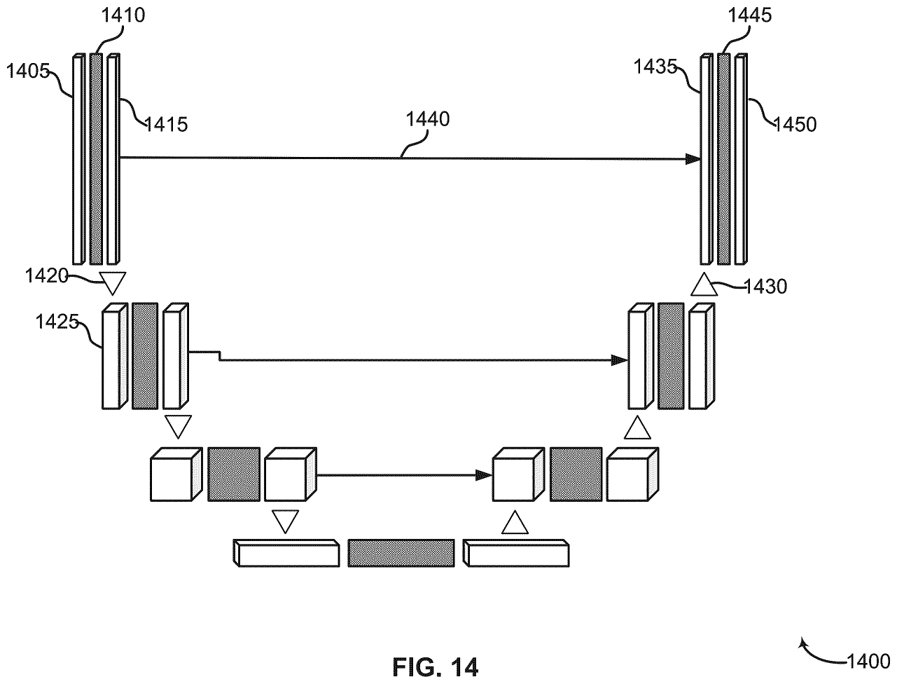

Image generation apparatus 800 may include an example of, or aspects of, the guided latent diffusion model described with reference to FIG. 13 and the U-Net described with reference to FIG. 14. In some embodiments, image generation apparatus 800 includes processor unit 805, memory unit 820, machine learning model 825, I/O module 810, user interface 815, and training component 840. Training component 840 updates parameters of the machine learning model 825 stored in memory unit 820. In some examples, the training component 840 is located outside the image generation apparatus 800.

Processor unit 805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

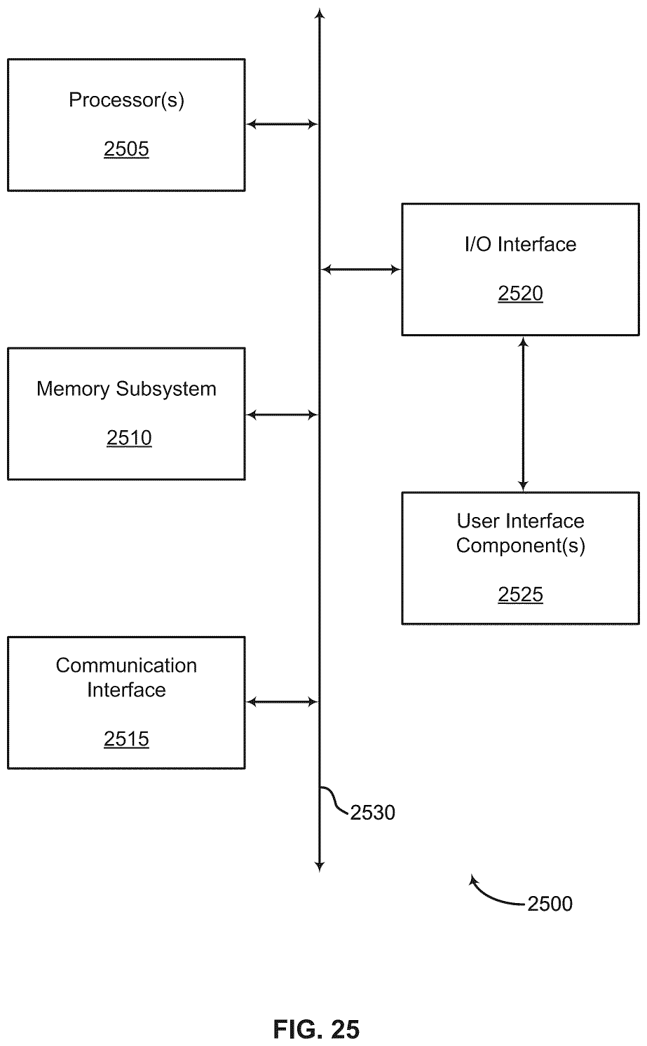

In some cases, processor unit 805 is configured to operate a memory array using a memory controller. In other cases, a memory controller is integrated into processor unit 805. In some cases, processor unit 805 is configured to execute computer-readable instructions stored in memory unit 820 to perform various functions. In some aspects, processor unit 805 includes special-purpose components for modem processing, baseband processing, digital signal processing, or transmission processing. According to some aspects, processor unit 805 comprises one or more processors described with reference to FIG. 25.

Memory unit 820 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 805 to perform various functions described herein.

In some cases, memory unit 820 includes a basic input/output system (BIOS) that controls basic hardware or software operations, such as an interaction with peripheral components or devices. In some cases, memory unit 820 includes a memory controller that operates memory cells of memory unit 820. For example, the memory controller may include a row decoder, column decoder, or both. In some cases, memory cells within memory unit 820 store information in the form of a logical state. According to some aspects, memory unit 820 is an example of the memory subsystem 2510 described with reference to FIG. 25.

According to some aspects, image generation apparatus 800 uses one or more processors of processor unit 805 to execute instructions stored in memory unit 820 to perform functions described herein. For example, the image generation apparatus 800 may obtain an input prompt and a target quality level. The image generation apparatus 800 selects an attention map size based on the target quality level. The image generation apparatus 800 generates, using an image generation model, an attention map having the selected attention map size. The image generation apparatus 800 generates, using the image generation model, a synthetic image, based on the input prompt and the attention map. The synthetic image depicts an element described by the input prompt.

The memory unit 820 may include a base image generation model 830 comprising a set of subnets and each of the set of subnets is trained to generate images using a different number of computation resources, respectively. For example, after training, the machine learning model 825 may perform inferencing operations as described with reference to FIGS. 2 and 15 to generate a synthetic image based on the input prompt and the target quality level, where the synthetic image depicts an element described by the input prompt.

In some embodiments, the machine learning model 825 is an artificial neural network (ANN) such as the guided latent diffusion model described with reference to FIG. 13 and the U-Net described with reference to FIG. 14. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 825 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the input improves as the ANN is trained, the hidden representation is progressively differentiated from earlier iterations.

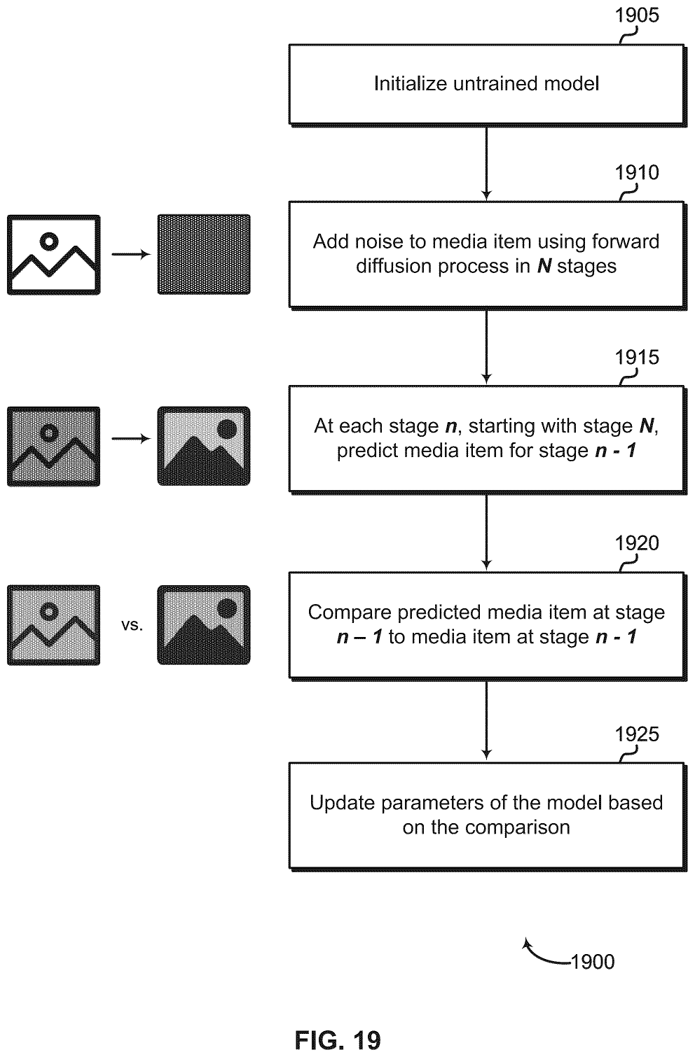

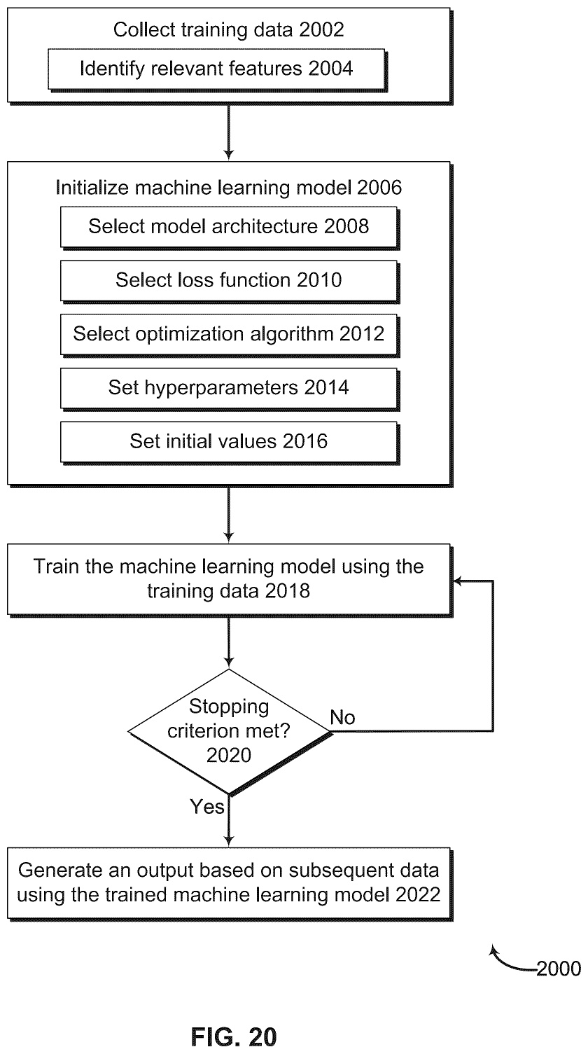

Training component 840 may train the machine learning model 825. For example, parameters of the machine learning model 825 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 19 and 20). The goal of the training process may be to find optimal values for the parameters that allow the machine learning model 825 to make accurate predictions or perform well on a given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 825 can be used to make predictions on new, unseen data (i.e., during inference).

I/O module 810 receives inputs from and transmits outputs of the image generation apparatus 800 to other devices or users. For example, I/O module 810 receives inputs for the machine learning model 825 and transmits outputs of the machine learning model 825. According to some aspects, I/O module 810 is an example of the I/O interface 2520 described with reference to FIG. 25.

According to some embodiments, machine learning model 825 obtains an input prompt and a target quality level. In some examples, machine learning model 825 selects an attention map size based on the target quality level. Machine learning model 825 generates, using an image generation model, an attention map having the selected attention map size. Machine learning model 825 generates, using the image generation model, a synthetic image, based on the input prompt and the attention map, where the synthetic image depicts an element described by the input prompt.

In some examples, machine learning model 825 obtains performance information, where the attention map size is selected based on the performance information. Machine learning model 825 is an example of, or includes aspects of, the corresponding element described with reference to FIG. 9. In one embodiment, machine learning model 825 includes base image generation model 830 and neural architecture search component 835.

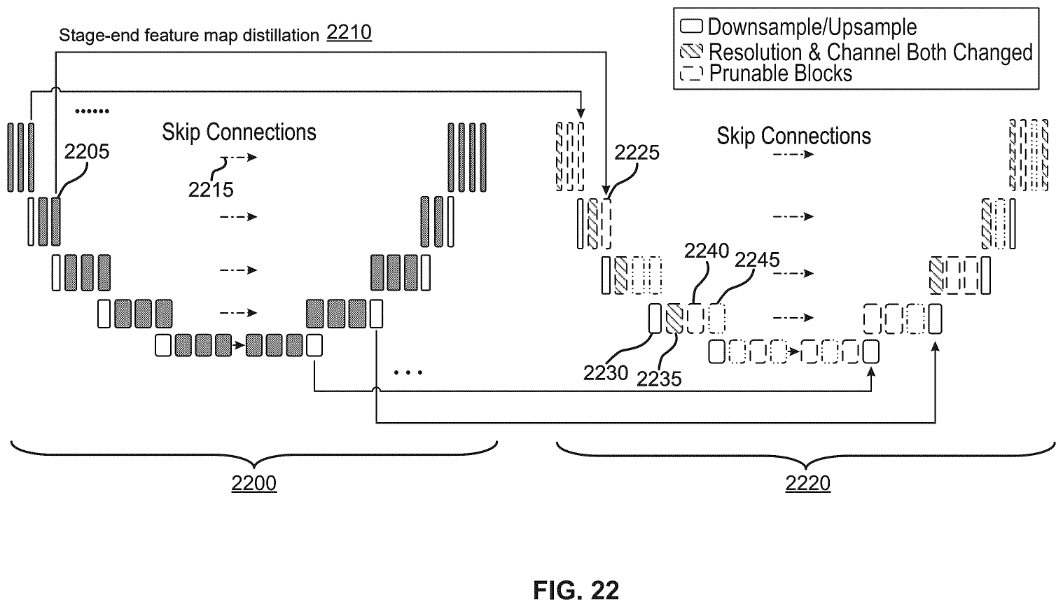

According to some embodiments, base image generation model 830 comprises a set of subnets and each of the set of subnets is trained to generate images using a different number of computation resources, respectively. In some examples, the base image generation model 830 includes a U-Net. In some examples, the base image generation model 830 includes a dynamic attention component configured to select an attention map size based on a target quality level. Base image generation model 830 is an example of, or includes aspects of, the corresponding element described with reference to FIG. 22.

According to some embodiments, neural architecture search component 835 selects a subnet of base image generation model 830 based on the target quality level, where the image generation model includes the subnet of the base image generation model 830.

According to some embodiments, neural architecture search component 835 performs a neural architecture search on the base image generation model 830. In some examples, neural architecture search component 835 computes a performance metric of the subnet, where the neural architecture search is based on the performance metric. In some examples, neural architecture search component 835 is configured to identify a plurality of subnets.

According to some embodiments, training component 840 obtains a training set including a training image. In some examples, training component 840 selects a subnet of a base image generation model 830. Training component 840 trains, using the training set, the base image generation model 830 by updating parameters of the selected subnet.

In some examples, training component 840 iteratively selects a set of subnets of the base image generation model 830. Training component 840 updates parameters of each of the set of subnets, respectively. In some examples, training component 840 identifies a subset of layers of the base image generation model 830. In some examples, training component 840 identifies a subset of channels of the base image generation model 830. In some examples, training component 840 reduces the resolution of a layer of the base image generation model 830. In some examples, training component 840 randomly selects a subnet search parameter.

In some examples, training component 840 obtains a teacher model. Training component 840 performs knowledge distillation between the teacher model and the base image generation model 830. In some examples, the knowledge distillation is performed based on a model output. In some examples, the knowledge distillation is performed based on an intermediate feature.

FIG. 9 shows an example of a base image generation model and subnet sampling according to aspects of the present disclosure. The example shown includes machine learning model 900, neural architecture search training scheduler 902, first transformer block 905, second transformer block 910, third transformer block 915, fourth transformer block 920, skip connection 925, and stage-end transformer block 930. Machine learning model 900 is an example of, or includes aspects of, the corresponding element described with reference to FIG. 8. In some cases, the neural architecture search training scheduler 902 may be referred to as a NAS training scheduler. NAS training scheduler 902 iteratively selects a set of subnets of a base image generation model. NAS training scheduler 902 updates parameters of each of the set of subnets, respectively.

In some examples, machine learning model 900 includes a U-Net comprising a set of stages. The machine learning model 900 is an example of, or includes aspects of, the corresponding element described with reference to U-Net 1400 of FIG. 14. In some examples, U-Net includes a set of stages that correspond to different resolutions, respectively. In the example shown in FIG. 9, U-Net includes five stages. The first resolution of a first stage is different from a second resolution of a second stage in the U-Net.

In some examples, a third stage of the U-Net includes four layers (i.e., first transformer block 905, second transformer block 910, third transformer block 915, fourth transformer block 920). The first transformer block 905 may also be referred to as a first layer. Second transformer block 910, third transformer block 915, and fourth transformer block 920 may be referred to as a second layer, a third layer, and a fourth layer, respectively. The term “block” and “layer” may be used interchangeably. Each layer has a number of channels (e.g., 256 channels, 512 channels). In some cases, the first transformer block 905 includes 256 channels.

In some examples, at the third stage of the U-Net, for second transformer block 910, both resolution and channel size are changed. Fourth transformer block 920 is a prunable block, i.e., fourth transformer block 920 is a layer to be skipped. At the fourth stage of the U-Net, two transformer blocks are layers to be skipped (i.e., two blocks/layers counting from the right). At the fifth stage of the U-Net, three transformer blocks are layers to be skipped (i.e., three blocks/layers counting from the right).

In some examples, the first transformer block 905 includes down-sampled features that have a resolution less than an initial resolution. In some examples, stage-end transformer block 930 includes up-sampled features that can be combined with intermediate features having the same resolution and number of channels via a skip connection 925. In some embodiments, the first transformer block 905 and stage-end transformer block 930 have the same resolution. Details with regard to an up-sampling process and a down-sampling process are further described in FIG. 14.

Skip connection 925 is an example of, or includes aspects of, the corresponding element described with reference to FIGS. 14 and 22. In an embodiment, for stage-end transformer block 930, machine learning model 900 performs self-distillation from a full capacity block.

First transformer block 905 is an example of, or includes aspects of, the corresponding element described with reference to FIG. 22. Second transformer block 910 is an example of, or includes aspects of, the corresponding element described with reference to FIG. 22. Third transformer block 915 is an example of, or includes aspects of, the corresponding element described with reference to FIG. 22. Fourth transformer block 920 is an example of, or includes aspects of, the corresponding element described with reference to FIG. 22.

FIG. 10 shows an example of a method of sampling subnets according to aspects of the present disclosure. The example shown includes layer skipping 1000, channel size reduction 1005, and resolution reduction 1010.

In some embodiments, layer skipping 1000 includes skipping one or more layers of a diffusion model (e.g., a U-Net shown in FIGS. 9 and 14). The one or more transformer layers are skipped during training. By skipping the one or more transformer layers, a machine learning model can achieve relatively fast image generation speed and reduced memory consumption.

Channel size reduction 1005 involves reducing a number of channels in a transformer layer of a diffusion model (e.g., a U-Net shown in FIGS. 9 and 14). Channel size reduction 1005 can reduce overall computations and memory usage.

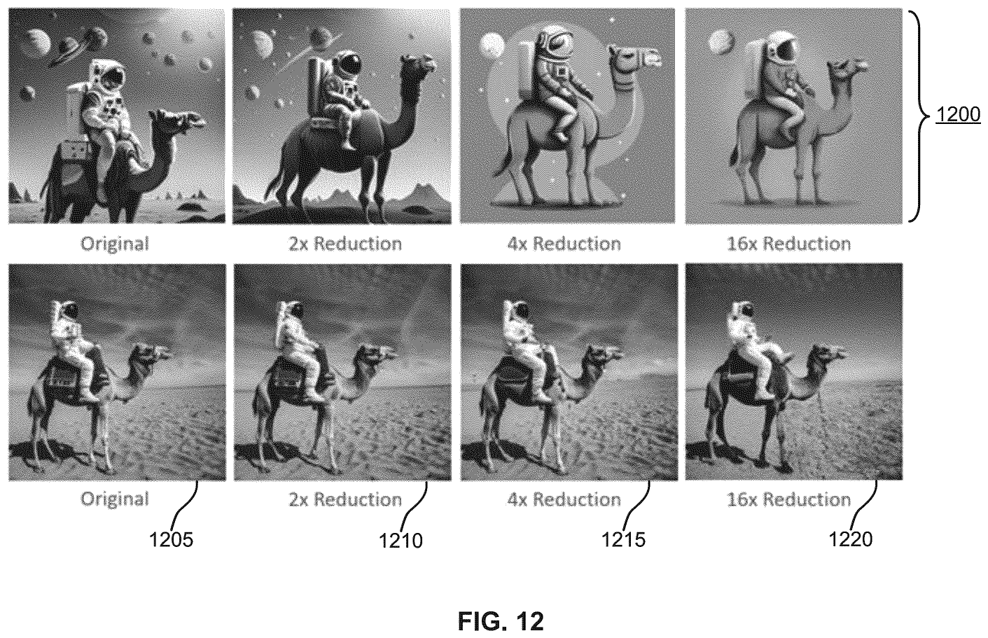

Resolution reduction 1010 involves reducing the input and output resolution by squeezing the resolution (e.g., height parameter, width parameter). In some examples, squeezing the resolution may involve down-sampling or compressing image data to reduce its dimensions while maintaining essential features, which can reduce overall computations and memory usage. Detail with regard to resolution reduction 1010 is also described in FIGS. 11-12.

In some embodiments, a machine learning model applies layer skipping 1000, channel size reduction 1005, resolution reduction 1010, or any combination thereof, when sampling subnets during each training step. In some examples, a base image generation model includes a set of subnets, where the set of subnets may differ in terms of layer skipping 1000, channel size reduction 1005, and resolution reduction 1010. Each subnet of the set of subnets is trained to generate images using a different number of computation resources, respectively.

FIG. 11 shows an example of a dynamic attention component 1130 according to aspects of the present disclosure. The example shown includes attention component 1100, original query object 1105, original key object 1110, original attention map 1115, original value object 1120, attention output 1125, dynamic attention component 1130, query object 1135, key object 1140, attention map 1145, value object 1150, and dynamic attention output 1155.

As for attention component 1100 (a self-attention component), attention component 1100 takes original query object 1105 and original key object 1110 as input. For example, original query object 1105 and original key object 1110 include H tokens and W tokens, respectively. Attention component 1100 computes original attention map 1115 based on original query object 1105 and original key object 1110. The attention component 1100 then computes a product of original attention map 1115 and original value object 1120 to obtain attention output 1125.

According to some embodiments, dynamic attention component 1130 selects a number of tokens for a key object 1140, where the attention map 1145 includes a product of the key object 1140 and a query object 1135. In some examples, dynamic attention component 1130 selects a number of tokens for a value object 1150 corresponding to the number of tokens for the key object 1140. Dynamic attention component 1130 computes a product of the attention map 1145 and the value object 1150.

In some examples, dynamic attention component 1130 reduces the token size of key object 1140 by half compared to original key object 1110 (e.g., original tokens divided by 2). Dynamic attention component 1130 reduces the token size of value object 1150 by half compared to original value object 1120 (e.g., original tokens divided by 2). Accordingly, key object 1140 has a smaller token size compared to original key object 1110. Value object 1150 has a smaller token size compared to original value object 1120.

Self-attention complexity grows quadratically regarding the token size (e.g., H×W). Dynamic attention component 1130 performs dynamic self-attention and increases computation efficiency by reducing token size of key object and value object. The term “self-attention” refers to a machine learning model in which representations of the input interact with each other to determine attention weights for the input. Self-attention can be distinguished from other attention models because the attention weights are determined at least in part by the input itself. In some cases, dynamic self-attention described in FIG. 11 can be used in post-training time and during fine-turning process.

In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function is used to normalize the attention weights. Finally, the attention weights are weighed together with their corresponding values. In the context of an attention network, the key and value are typically vectors or matrices that are used to represent the input data. The key is used to determine which parts of the input the attention mechanism should focus on, while the value is used to represent the actual data being processed.

FIG. 12 shows an example of synthetic images according to aspects of the present disclosure. The example shown includes baseline images 1200, first synthetic image 1205, second synthetic image 1210, third synthetic image 1215, and fourth synthetic image 1220.

Baseline images 1200 are generated using token merge technique and they are to be compared against synthetic images generated using dynamic self-attention methods described in FIG. 11. First synthetic image 1205, second synthetic image 1210, third synthetic image 1215, and fourth synthetic image 1220 are generated using dynamic self-attention.

First synthetic image 1205 is generated using attention component 1100 in FIG. 11 without token size reduction for key object or value object. Second synthetic image 1210 is generated via 2× token size reduction. Third synthetic image 1215 is generated via 4× token size reduction. Fourth synthetic image 1220 is generated via 16× token size reduction. For example, comparing and contrasting the four synthetic images on the second row, fourth synthetic image 1220 has decreased image quality in terms of colors, fine-grained details, and texture, while maintaining overall quality and key image attributes. It takes less computation resource and less time to generate the fourth synthetic image 1220 compared to the other three synthetic images.

In contrast to baseline images 1200 that are generated via token merge, synthetic images (1205, 1210, 1215, and 1220) show increased identity preservation, detail retention, and superior quality in image generation.

FIG. 13 shows an example of a guided latent diffusion model 1300 according to aspects of the present disclosure. The guided latent diffusion model 1300 depicted in FIG. 13 is an example of, or includes aspects of, the corresponding element (i.e., base image generation model 830) described with reference to FIG. 8.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1300 may take an original image 1305 in a pixel space 1310 as input and apply and image encoder 1315 to convert original image 1305 into original image features 1320 in a latent space 1325. Then, a forward diffusion process 1330 gradually adds noise to the original image features 1320 to obtain noisy features 1335 (also in latent space 1325) at various noise levels.

Next, a reverse diffusion process 1340 (e.g., a U-Net ANN) gradually removes the noise from the noisy features 1335 at the various noise levels to obtain denoised image features 1345 in latent space 1325. In some examples, the denoised image features 1345 are compared to the original image features 1320 at each of the various noise levels, and parameters of the reverse diffusion process 1340 of the diffusion model are updated based on the comparison. Finally, an image decoder 1350 decodes the denoised image features 1345 to obtain an output image 1355 in pixel space 1310. In some cases, an output image 1355 is created at each of the various noise levels. The output image 1355 can be compared to the original image 1305 to train the reverse diffusion process 1340.

In some cases, image encoder 1315 and image decoder 1350 are pre-trained prior to training the reverse diffusion process 1340. In some examples, the image encoder 1315 and image decoder 1350 are trained jointly, or they are fine-tuned jointly with the reverse diffusion process 1340.

The reverse diffusion process 1340 can also be guided based on a text prompt 1360, or another guidance prompt, such as an image, a layout, a segmentation map, etc. The text prompt 1360 can be encoded using a text encoder 1365 (e.g., a multimodal encoder) to obtain guidance features 1370 in guidance space 1375. The guidance features 1370 can be combined with the noisy features 1335 at one or more layers of the reverse diffusion process 1340 to ensure that the output image 1355 includes content described by the text prompt 1360. For example, guidance features 1370 can be combined with the noisy features 1335 using a cross-attention block within the reverse diffusion process 1340.

FIG. 14 shows an example of a U-Net 1400 according to aspects of the present disclosure. In some examples, U-Net 1400 is an example of the component that performs the reverse diffusion process 1340 of guided latent diffusion model 1300 described with reference to FIG. 13 and includes architectural elements of the base image generation model 830 described with reference to FIG. 8. The U-Net 1400 depicted in FIG. 14 is an example of, or includes aspects of, the architecture used within the reverse diffusion process described with reference to FIG. 13.

In some examples, diffusion models are based on a neural network architecture known as a U-Net. The U-Net 1400 takes input features 1405 having an initial resolution and an initial number of channels and processes the input features 1405 using an initial neural network layer 1410 (e.g., a convolutional network layer) to produce intermediate features 1415. The intermediate features 1415 are then down-sampled using a down-sampling layer 1420 such that down-sampled features 1425 have a resolution less than the initial resolution and a number of channels greater than the initial number of channels.

This process is repeated multiple times, and then the process is reversed. That is, the down-sampled features 1425 are up-sampled using up-sampling process 1430 to obtain up-sampled features 1435. The up-sampled features 1435 can be combined with intermediate features 1415 having the same resolution and number of channels via a skip connection 1440. These inputs are processed using a final neural network layer 1445 to produce output features 1450. In some cases, the output features 1450 have the same resolution as the initial resolution and the same number of channels as the initial number of channels.

In some cases, U-Net 1400 takes additional input features to produce conditionally generated output. For example, the additional input features could include a vector representation of an input prompt. The additional input features can be combined with the intermediate features 1415 within the neural network at one or more layers. For example, a cross-attention module can be used to combine the additional input features and the intermediate features 1415.

In FIGS. 8-14, an apparatus and method for image generation are described. One or more embodiments of the apparatus and method include at least one processor; at least one memory including instructions executable by the at least one processor; and a base image generation model comprising parameters in the at least one memory, wherein the base image generation model comprises a plurality of subnets and each of the plurality of subnets is trained to generate images using a different number of computation resources, respectively.

In some examples, the base image generation model comprises a U-Net. Some examples of the apparatus and method further include a neural architecture search component configured to identify the plurality of subnets. In some examples, the base image generation model comprises a dynamic attention component configured to select an attention map size based on a target quality level.

### Image Generation and Neural Architecture Search

FIG. 15 shows an example of a diffusion process 1500 according to aspects of the present disclosure. In some examples, diffusion process 1500 describes an operation of the base image generation model 830 described with reference to FIG. 8, such as the reverse diffusion process 1340 of guided latent diffusion model 1300 described with reference to FIG. 13.

As described above with reference to FIG. 13, using a diffusion model can involve both a forward diffusion process 1505 for adding noise to a media item (or features in a latent space) and a reverse diffusion process 1510 for denoising the media item (or features) to obtain a denoised media item. The forward diffusion process 1505 can be represented as q(xₜ|xₜ₋₁), and the reverse diffusion process 1510 can be represented as p(xₜ₋₁|xₜ). In some cases, the forward diffusion process 1505 is used during training to generate media items with successively greater noise, and a neural network is trained to perform the reverse diffusion process 1510 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1510, the model begins with noisy data x_{T}, such as a noisy media item 1515 and denoises the data to obtain the p(xₜ₋₁|xₜ). At each step t−1, the reverse diffusion process 1510 takes xₜ, such as first intermediate media item 1520, and t as input. Here, t represents a step in the sequence of transitions associated with different noise levels, The reverse diffusion process 1510 outputs xₜ₋₁, such as second intermediate media item 1525 iteratively until x_{T} reverts back to x₀, the original media item 1530. The reverse process can be represented as:

$${p}_{θ} ( {x}_{t - 1} \vert {x}_{t} ) : = N ( {x}_{t - 1} ; {μ}_{θ} ( {x}_{t} , t ) , {Σ}_{θ} ( {x}_{t} , t ) ) . \qquad ( 2 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) , \qquad ( 3 )$$

where p(x_{T})=N(x_{T}; 0, l) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

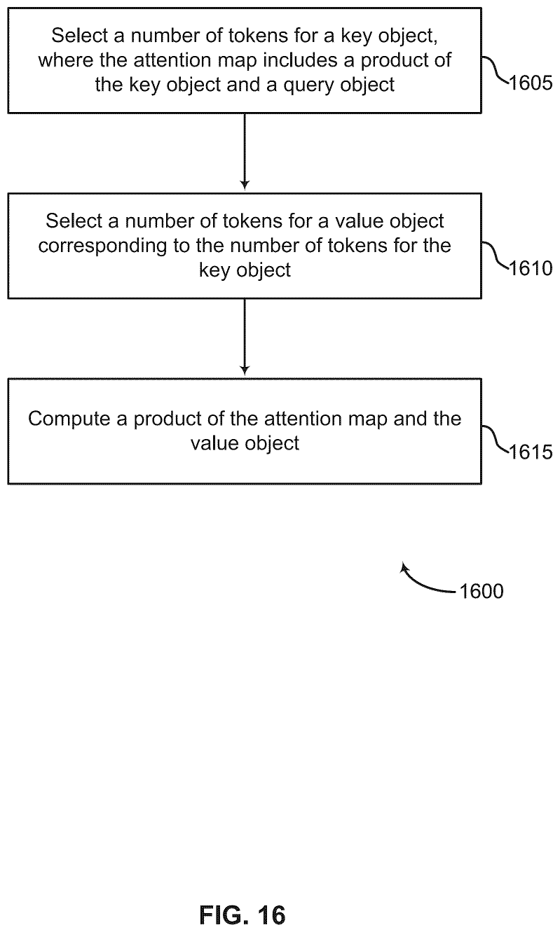

FIG. 16 shows an example of a method 1600 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1605, the system selects a number of tokens for a key object, where the attention map includes a product of the key object and a query object. In some cases, the operations of this step refer to, or may be performed by, a dynamic attention component as described with reference to FIG. 11.

At operation 1610, the system selects a number of tokens for a value object corresponding to the number of tokens for the key object. In some cases, the operations of this step refer to, or may be performed by, a dynamic attention component as described with reference to FIG. 11.

At operation 1615, the system computes a product of the attention map and the value object. In some cases, the operations of this step refer to, or may be performed by, a dynamic attention component as described with reference to FIG. 11.

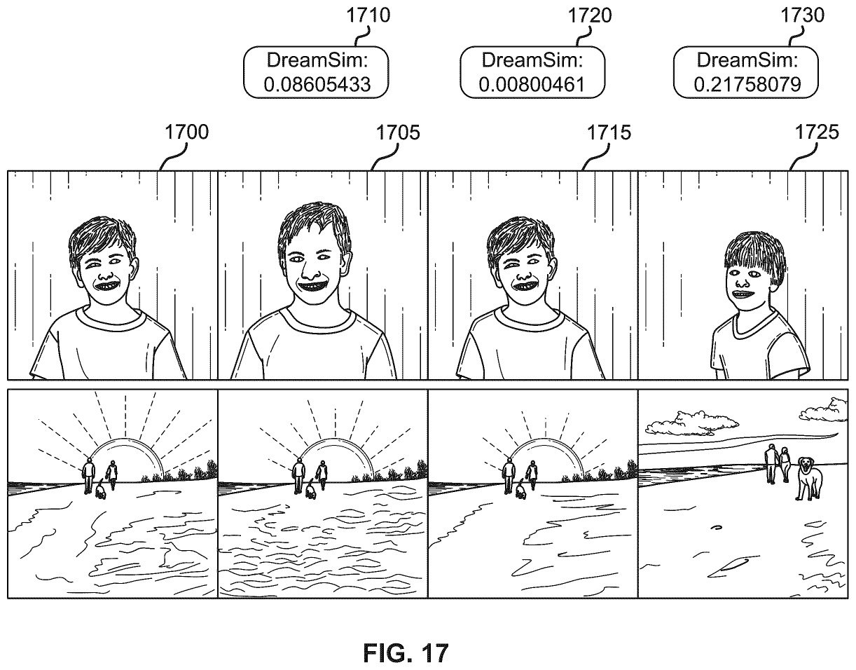

FIG. 17 shows an example of synthetic images for searching according to aspects of the present disclosure. The example shown includes baseline image 1700, first image 1705, first score 1710, second image 1715, second score 1720, third image 1725, and third score 1730.

A baseline image 1700 is generated using a base image generation model. The base image generation model is an example of, or includes aspects of, the corresponding element described with reference to base image generation model 830 in FIG. 8.

In an embodiment, a neural architecture search component identifies a set of subnets. Each of the set of subnets is trained to generate images using a different number of computation resources, respectively. The neural architecture search component selects a subnet of the base image generation model. The neural architecture search component computes a performance metric of the subnet, where the neural architecture search is based on the performance metric. The neural architecture search component is an example of, or includes aspects of, the corresponding element described with reference to neural architecture search component 835 in FIG. 8.

The baseline image 1700 is used to compute a similarity score of a synthetic image. First image 1705 has a first score 1710 (e.g., score=0.08605433). In some examples, the score indicates a level of similarity between two images. Second image 1715 has a second score 1720 (e.g., score=0.00800461). Third image 1725 has a third score 1730 (e.g., score=0.21758079).

In some examples, a higher score indicates more differences and mismatches between two images. The difference between baseline image 1700 and third image 1725 is larger than the difference between baseline image 1700 and second image 1715. That is, second image 1715 is substantially similar to baseline image 1700. The second score 1720 also indicates a high degree of similarity between baseline image 1700 and second image 1715.

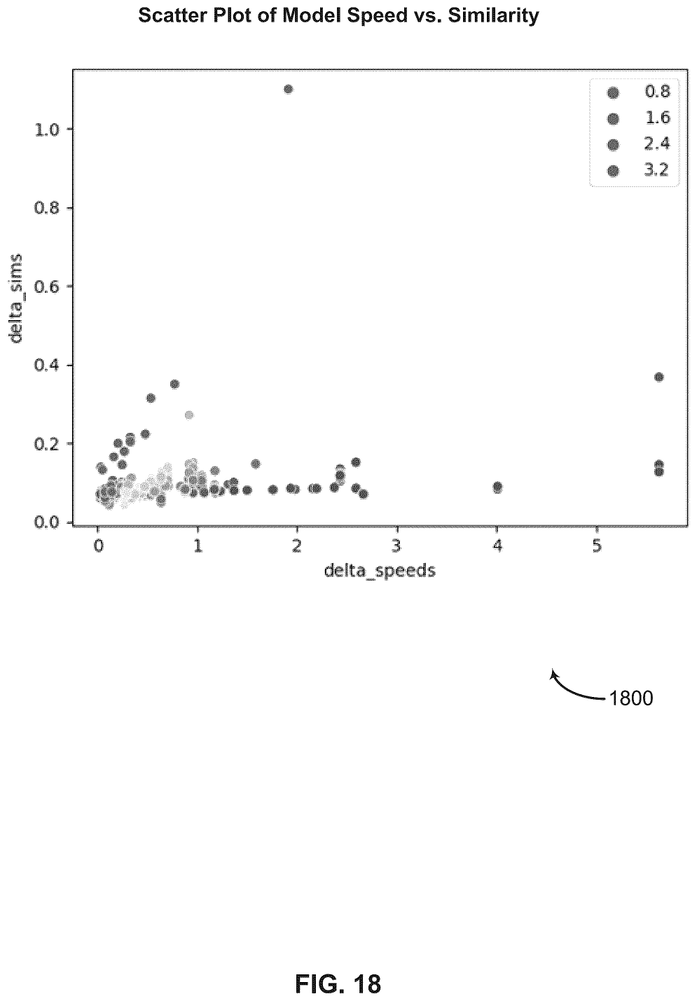

FIG. 18 shows an example of a search diagram showing speed versus similarity score according to aspects of the present disclosure. The example shown includes a search diagram 1800. For example, search diagram 1800 includes a scatter plot. The x-axis refers to performance metric (e.g., speed) while the y-axis refers to a target quality level (e.g., similarity between a synthetic image and a baseline image). The data points in search diagram 1800 represent different subnet configurations. In some cases, greedy search is used to search for a subnet that can meet the performance metric (e.g., speed) and the target quality level.

In an embodiment, a neural architecture search component identifies a set of subnets of a base image generation model. The neural architecture search component performs a neural architecture search on the base image generation model. In some examples, the neural architecture search component, via greedy search, identifies a subnet that can obtain the desired performance and image quality. The neural architecture search component is an example of, or includes aspects of, the corresponding element described with reference to neural architecture search component 835 in FIG. 8.

### Training and Evaluation

FIG. 19 shows an example of a method 1900 for training a diffusion model according to aspects of the present disclosure. In some embodiments, the method 1900 describes an operation of the training component 840 described for configuring the base image generation model 830 as described with reference to FIG. 8. The method 1900 represents an example for training a reverse diffusion process as described above with reference to FIG. 13. In some examples, these operations are performed by a system including a processor executing a set of codes to control functional elements of an apparatus, such as the guided latent diffusion model described in FIG. 13.

Additionally or alternatively, certain processes of method 1900 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1905, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1910, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1915, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1920, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1925, the system updates parameters of the model based on the comparison. For example, parameters of a U-Net may be updated using gradient descent. Time-dependent parameters of the Gaussian transitions can also be learned.

FIG. 20 shows an example of training a machine learning model according to aspects of the present disclosure. FIG. 20 shows a flow diagram depicting an algorithm as a step-by-step procedure 2000 in an example implementation of operations performable for training a machine-learning model. In some embodiments, the procedure 2000 describes an operation of the training component 840 described for configuring the base image generation model 830 as described with reference to FIG. 8. The procedure 2000 provides one or more examples of generating training data, use of the training data to train a machine-learning model, and use of the trained machine-learning model to perform a task.

To begin in this example, a machine-learning system collects training data (block 2002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2006). Initialization of the machine-learning model includes selecting a model architecture (block 2008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2010). The loss function is utilized to measure a difference between an output of the machine-learning model (i.e., predictions) and target values (e.g., as expressed by the training data) to be used to train the machine-learning model. Additionally, an optimization algorithm is selected (2012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2020), the procedure 2000 continues training of the machine-learning model using the training data (block 2018) in this example.

If the stopping criterion is met (“yes” from decision block 2020), the trained machine-learning model is then utilized to generate an output based on subsequent data (block 2022). The trained machine-learning model, for instance, is trained to perform a task as described above and therefore once trained is configured to perform that task based on subsequent data received as an input and processed by the machine-learning model.

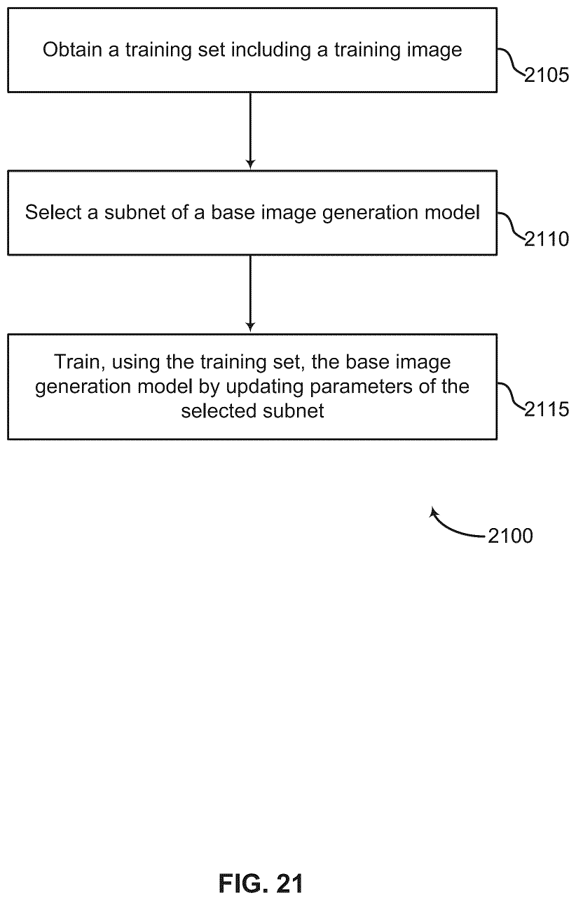

FIG. 21 shows an example of a method 2100 for training a base image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 2105, the system obtains a training set including a training image. In some cases, the operations of this step refer to, or may be performed by, a training component as described with reference to FIG. 8. In some cases, obtaining a training set can include creating training data for training a base image generation model.

At operation 2110, the system selects a subnet of a base image generation model. In some cases, the operations of this step refer to, or may be performed by, a training component as described with reference to FIG. 8. In an embodiment, selecting a subnet of the base image generation model may include pruning one or more layers, reducing channel size for one or more layers, modifying resolution, or any combination thereof.

At operation 2115, the system trains, using the training set, the base image generation model by updating parameters of the selected subnet. In some cases, the operations of this step refer to, or may be performed by, a training component as described with reference to FIG. 8.

In some examples, the base image generation model is initialized using random values. In other examples, the base image generation model is initialized based on a pre-trained model. In some examples, the base image generation model includes base parameters from a pre-trained model.

FIG. 22 shows an example of knowledge distillation according to aspects of the present disclosure. The example shown includes teacher model 2200, teacher stage-end block 2205, stage-end distillation 2210, skip connection 2215, base image generation model 2220, student stage-end block 2225, first transformer block 2230, second transformer block 2235, third transformer block 2240, and fourth transformer block 2245. Base image generation model 2220 is an example of, or includes aspects of, the corresponding element described with reference to FIG. 8.

In an embodiment, a machine learning model includes a teacher model 2200 and a base image generation model 2220 (i.e., a student model). The machine learning model is an example of, or includes aspects of, the corresponding element described with reference to machine learning model 825 of FIG. 8.

In some examples, teacher model 2200 includes a U-Net comprising a set of stages. The teacher model 2200 is an example of, or includes aspects of, the corresponding element described with reference to U-Net 1400 of FIG. 14. In some examples, U-Net includes a set of stages that correspond to different resolutions, respectively. In the example shown in FIG. 22, teacher U-Net includes five stages. A first resolution of a first stage is different from a second resolution of a second stage in the teacher U-Net.

The teacher model 2200 is a diffusion model trained at full capacity. The machine learning model applies knowledge distillation on final output. Additionally and alternatively, the machine learning model applies intermediate stage-end feature map distillation. As shown in FIG. 22, stage-end distillation 2210 involves feature map distillation from teacher stage-end block 2205 to student stage-end block 2225.

In some examples, base image generation model 2220 (i.e., a student model) includes a U-Net comprising a set of stages. The base image generation model 2220 is an example of, or includes aspects of, the corresponding element described with reference to U-Net 1400 of FIG. 14. In some examples, U-Net includes a set of stages that correspond to different resolutions, respectively. In the example shown in FIG. 22, student U-Net includes five stages. A first resolution of a first stage is different from a second resolution of a second stage in the student U-Net.

In some examples, a fourth stage of base image generation model 2220 (i.e., the student U-Net) includes four layers (i.e., first transformer block 2230, second transformer block 2235, third transformer block 2240, and fourth transformer block 2245). The first transformer block 2230 may also be referred to as a first layer. Second transformer block 2235, third transformer block 2240, and fourth transformer block 2245 may be referred to as a second layer, a third layer, and a fourth layer, respectively. The term “block” and “layer” may be used interchangeably. Each layer has a number of channels (e.g., 256 channels, 512 channels). In some cases, the first transformer block 2230 includes 256 channels.

In some examples, at the fourth stage of the student U-Net, for second transformer block 2235, both resolution and channel size are changed. Fourth transformer block 2245 is a prunable block, i.e., fourth transformer block 2245 is a layer to be skipped. At the fifth stage of the student U-Net, two transformer blocks are layers to be skipped (i.e., the second block and the fourth block counting from the left).

In some examples, the first transformer block 2230 includes down-sampled features that have a resolution less than an initial resolution. In some examples, teacher stage-end block 2205 and student stage-end block 2225 have the same resolution. Details with regard to an up-sampling process and a down-sampling process are further described in FIG. 14.

In some embodiments, teacher model 2200 includes a diffusion U-Net and a base image generation model 2220 includes a diffusion U-Net. A U-Net architecture includes encoder blocks and decoder blocks. Skip connection 2215 directly connects corresponding layers in the encoder of U-Net and decoder paths, bypassing a bottleneck layer. Skip connection 2215 enables the decoder to access high-resolution feature maps from the encoder, which helps preserve fine-grained details that might otherwise be lost as the encoder path reduces the spatial dimensions of an input image. This helps the decoder reconstruct the segmentation map with greater precision. Skip connection 2215 is an example of, or includes aspects of, the corresponding element described with reference to FIGS. 9 and 14.

First transformer block 2230 is an example of, or includes aspects of, the corresponding element described with reference to FIG. 9. Second transformer block 2235 is an example of, or includes aspects of, the corresponding element described with reference to FIG. 9. Third transformer block 2240 is an example of, or includes aspects of, the corresponding element described with reference to FIG. 9. Fourth transformer block 2245 is an example of, or includes aspects of, the corresponding element described with reference to FIG. 9.

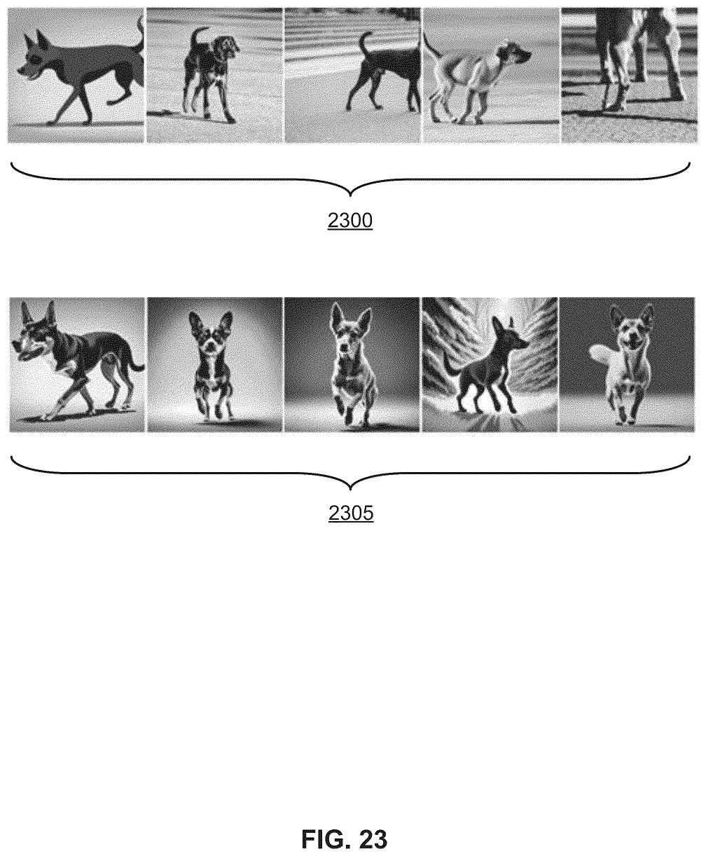

FIG. 23 shows an example of synthetic images according to aspects of the present disclosure. The example shown includes a first set of synthetic images 2300 and a second set of synthetic images 2305.

The first set of synthetic images 2300 are generated using an image generation model trained on ground-truth training samples without knowledge distillation. A second set of synthetic images 2305 are generated using an image generation model trained on ground-truth training samples along with knowledge distillation. Examples in FIG. 23 demonstrate that applying knowledge distillation during training can increase image quality of generated images. For example, the second set of synthetic images 2305 includes more fine-grained details and texture than the first set of synthetic images 2300.

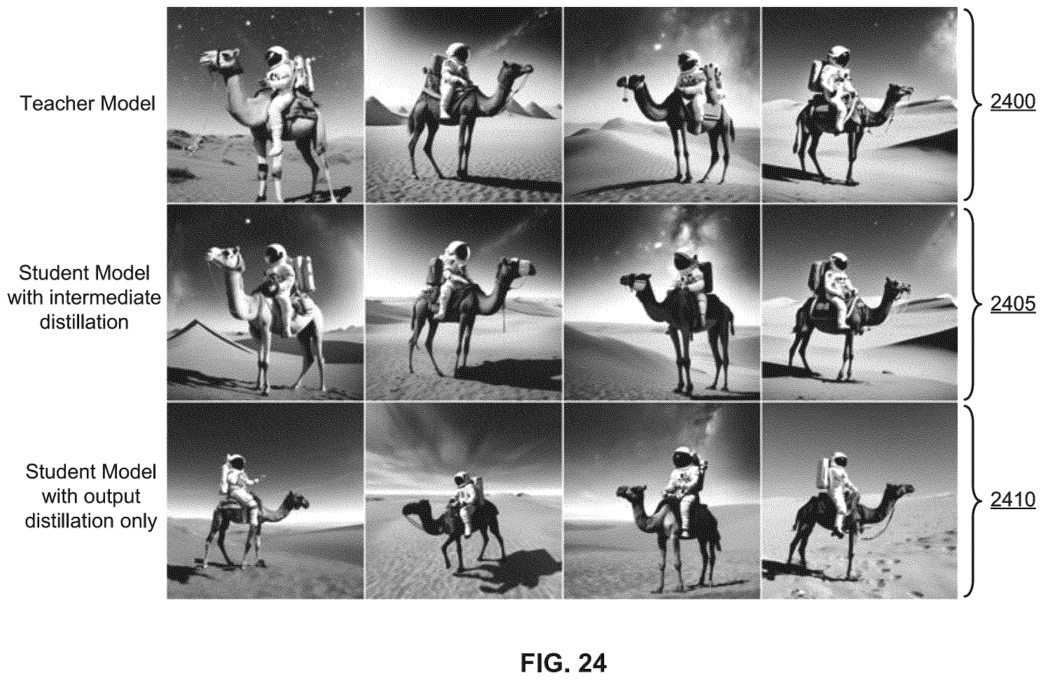

FIG. 24 shows an example of synthetic images according to aspects of the present disclosure. The example shown includes a first set of synthetic images 2400, a second set of synthetic images 2405, and a third set of synthetic images 2410.

The first set of synthetic images 2400 are generated by a teacher model. The teacher model is an example of, or includes aspects of, the corresponding element described with reference to teacher model 2200 in FIG. 22. A second set of synthetic images 2405 are generated using a student model applying intermediate stage-end feature map distillation. The student model is an example of, or includes aspects of, the corresponding element described with reference to base image generation model 2220 (i.e., a student model) in FIG. 22. Intermediate stage-end feature map distillation involves passing knowledge from the teacher model to the student model at one or more intermediate stages within a U-Net.

A third set of synthetic images 2410 are generated using a student model applying output distillation (other than intermediate stage-end feature map distillation). Output distillation involves passing knowledge from the teacher model to the student model by conducting knowledge distillation on a final output. In some examples, the second set of synthetic images 2405 has improved image quality (e.g., detail, texture, color, diversity) than the third set of synthetic images 2410.

In FIGS. 19-24, a method, apparatus, and non-transitory computer readable medium for image generation are described. One or more embodiments of the method, apparatus, and non-transitory computer readable medium include obtaining a training set including a training image; selecting a subnet of a base image generation model; and training, using the training set, the base image generation model by updating parameters of the selected subnet.

Some examples of the method, apparatus, and non-transitory computer readable medium further include iteratively selecting a plurality of subnets of the base image generation model. Some examples further include updating parameters of each of the plurality of subnets, respectively.

Some examples of the method, apparatus, and non-transitory computer readable medium further include identifying a subset of layers of the base image generation model. Some examples of the method, apparatus, and non-transitory computer readable medium further include identifying a subset of channels of the base image generation model. Some examples of the method, apparatus, and non-transitory computer readable medium further include reducing a resolution of a layer of the base image generation model.

Some examples of the method, apparatus, and non-transitory computer readable medium further include randomly selecting a subnet search parameter. Some examples of the method, apparatus, and non-transitory computer readable medium further include obtaining a teacher model. Some examples further include performing knowledge distillation between the teacher model and the base image generation model. In some examples, the knowledge distillation is performed based on a model output. In some examples, the knowledge distillation is performed based on an intermediate feature.

Some examples of the method, apparatus, and non-transitory computer readable medium further include performing a neural architecture search on the base image generation model. Some examples of the method, apparatus, and non-transitory computer readable medium further include computing a performance metric of the subnet, wherein the neural architecture search is based on the performance metric.

FIG. 25 shows an example of a computing device 2500 for image generation according to aspects of the present disclosure. The computing device 2500 may be an example of the image generation apparatus 800 described with reference to FIG. 8. In one aspect, computing device 2500 includes processor(s) 2505, memory subsystem 2510, communication interface 2515, I/O interface 2520, user interface component(s) 2525, and channel 2530.

In some embodiments, computing device 2500 is an example of, or includes aspects of, the machine learning model 825 of FIG. 8. In some embodiments, computing device 2500 includes one or more processors 2505 that can execute instructions stored in memory subsystem 2510 to perform media generation.

According to some aspects, computing device 2500 includes one or more processors 2505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2515 operates at a boundary between communicating entities (such as computing device 2500, one or more user devices, a cloud, and one or more databases) and channel 2530 and can record and process communications. In some cases, communication interface 2515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2520 is controlled by an I/O controller to manage input and output signals for computing device 2500. In some cases, I/O interface 2520 manages peripherals not integrated into computing device 2500. In some cases, I/O interface 2520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2520 or via hardware components controlled by the I/O controller.

According to some aspects, user interface component(s) 2525 enables a user to interact with computing device 2500. In some cases, user interface component(s) 2525 include an audio device, such as an external speaker system, an external display device such as a display screen, an input device (e.g., a remote-control device interfaced with a user interface directly or through the I/O controller), or a combination thereof. In some cases, user interface component(s) 2525 include a GUI.

Performance of apparatus, systems and methods of the present disclosure have been evaluated, and results indicate embodiments of the present disclosure have obtained increased performance over conventional technology. Example experiments demonstrate that the image generation apparatus described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a target quality level and an input prompt describing an image element;
selecting an attention map size based on the target quality level;
generating, using an image generation model, an attention map having the attention map size selected based on the target quality level; and
generating, using the image generation model, a synthetic image based on the input prompt and the attention map, wherein the synthetic image depicts the image element with the target quality level.

2. The method of claim 1, further comprising:
obtaining performance information, wherein the attention map size is selected based on the performance information.

3. The method of claim 1, further comprising:
selecting a subnet of a base image generation model with the selected attention map size based on the target quality level, wherein the image generation model comprises the subnet of the base image generation model.

4. The method of claim 1, wherein selecting the attention map size comprises:
selecting a number of tokens for a key object, wherein the attention map comprises a product of the key object and a query object.

5. The method of claim 4, wherein selecting the attention map size comprises:
selecting a number of tokens for a value object corresponding to the number of tokens for the key object; and
computing a product of the attention map and the value object.

6. A method comprising:
obtaining a training set including a training image;
selecting a subnet of a base image generation model; and
training, using the training set, the base image generation model by updating parameters of the selected subnet.

7. The method of claim 6, wherein training the base image generation model comprises:
iteratively selecting a plurality of subnets of the base image generation model; and
updating parameters of each of the plurality of subnets, respectively.

8. The method of claim 6, wherein selecting the subnet comprises:
identifying a subset of layers of the base image generation model.

9. The method of claim 6, wherein selecting the subnet comprises:
identifying a subset of channels of the base image generation model.

10. The method of claim 6, wherein selecting the subnet comprises:
reducing a resolution of a layer of the base image generation model.

11. The method of claim 6, wherein selecting the subnet comprises:
randomly selecting a subnet search parameter.

12. The method of claim 6, wherein training the base image generation model comprises:
obtaining a teacher model; and
performing knowledge distillation between the teacher model and the base image generation model.

13. The method of claim 12, wherein:
the knowledge distillation is performed based on a model output.

14. The method of claim 12, wherein:
the knowledge distillation is performed based on an intermediate feature.

15. The method of claim 6, further comprising:
performing a neural architecture search on the base image generation model.

16. The method of claim 15, further comprising:
computing a performance metric of the subnet, wherein the neural architecture search is based on the performance metric.

17. An apparatus comprising:
at least one processor;
at least one memory including instructions executable by the at least one processor; and
a base image generation model comprising parameters in the at least one memory, wherein the base image generation model comprises a plurality of subnets and each of the plurality of subnets is trained to generate images using a different number of computation resources, respectively.

18. The apparatus of claim 17, wherein:
the base image generation model comprises a U-Net.

19. The apparatus of claim 17, further comprising:
a neural architecture search component configured to identify the plurality of subnets.

20. The apparatus of claim 17, wherein:
the base image generation model comprises a dynamic attention component configured to select an attention map size based on a target quality level.
